(19) United States
(12) Patent Application Publication
(10) Pub. No.: US 2011/0284133 A1
(43) Pub. Date: Nov. 24, 2011

(54) CARBONITRIDED PART AND PROCESS FOR PRODUCING CARBONITRIDED PART

(75) Inventors: Naoyuki Sano, Takarazuka (JP); Masayuki Horimoto, Nishinomiya (JP); Yoshinari Okada, Wako-shi (JP); Masaki Amano, Wako-shi (JP); Akihito Ninomiya, Wako-shi (JP)

(73) Assignees: HONDA MOTOR CO., LTD., Tokyo (JP); SUMITOMO METAL INDUSTRIES, LTD., Osaka (JP)

(21) Appl. No.: 13/116,405

(22) Filed: May 26, 2011

Related U.S. Application Data
(63) Continuation of application No. PCT/JP2009/070152, filed on Dec. 1, 2009.

(30) Foreign Application Priority Data
Dec. 2, 2008 (JP) 2008-307250

(51) Int. Cl. C23C 8/32; B32B 15/04

(52) U.S. Cl. 148/218; 148/318

(57) ABSTRACT

A carbonitrided part, where a base steel contains, in mass percent, C: 0.10 to 0.35%, Si: 0.15 to 1.0%, Mn: 0.30 to 1.0%, Cr: 0.40 to 2.0%, S≦0.05%, and according to need further Mo≦0.50%, with the balance being Fe and impurities, and in the region to a position of effective hardening depth from the surface of a hardened layer of the carbonitrided part, iron nitride particles of ε-Fe₃N and/or ζ-Fe₂N are dispersed, and retained austenite is decomposed into bainitic ferrite, Fe₃C, and α″-Fe₁₆N₂ has excellent abrasion strength and high pitting strength, although the base steel is a low-cost one with less content of Mo of an expensive alloy element or without addition of Mo. This carbonitrided part can be produced, for example, by subjecting the base steel part to carburizing in which the base steel part is held in a carburizing atmosphere at 900 to 950° C. and successively to carbonitriding in which the base steel part is held in a carbonitriding atmosphere with a nitrogen potential of 0.2 to 0.6% at 800 to 900° C., subsequently quenching the base steel part, and thereafter tempering the base steel part by heating to a temperature in the range of more than 250° C. to not more than 350° C.

This application is a continuation of the international application PCT/JP2009/070152 field on Dec. 1, 2009, the entire content of which is herein incorporated by reference.

### TECHNICAL FIELD

The present invention relates to a part subjected to carbonitriding treatment (hereinafter referred to as “carbonitrided part”) and a process for producing carbonitrided parts. More specifically, the present invention relates to a carbonitrided part suitable for a power transmission component requiring excellent rolling contact fatigue strength, in particular, a large strength to pitting and excellent abrasion strength, and a process for producing the carbonitrided parts.

### BACKGROUND ART

Power transmission components such as a gear used for a transmission of a car and a pulley for a belt-type Continuously Variable Transmission (CVT) are conventionally produced as follows: an alloy steel for machine structural use defined in JIS G 4053 (2003) is formed into a predetermined shape by processing such as forging and cutting, and subjected to carburizing and quenching, or carbonitriding and quenching, and then, further to tempering.

In recent years, requirements on energy efficiency of a car have been becoming severe more and more. Under this circumstance, in order to realize weight saving of a car directly linked to improvement of energy efficiency, for the above-described components, more miniaturization and higher strength are required, and improvements on an ultimate strength to pitting, which is a kind of rolling contact fatigue, hereinafter called “pitting strength”, and abrasion strength have been taken seriously.

In order to improve the pitting strength and abrasion strength, generally, it is effective to harden the component surface by carburizing or carbonitriding. Therefore, an alloy steel for machine structural use, containing carbon of about 0.2% in mass %, such as a manganese type typified by SMn420, a manganese chromium type typified by SMnC420, a chromium type typified by SCr420 and a chromium molybdenum type typified by SCM420, has been used as a material of carburized component and carbonitrided component. When it comes to an element included in the above-described alloy steels, the prices of rare metal elements are soared recently, in particular, a remarkable price hike in Mo is observed.

Regarding the “carbonitriding,” there are “gas carbonitriding” where ammonia gas is mixed in a carburizing atmosphere to undergo carburizing and nitriding at the same time and the like, and nitrogen is thought to have an effect of enhancing a so-called “temper softening strength.” However, nitrogen has an effect of suppressing diffusion of carbon, in addition, since nitriding treatment is conducted at a lower temperature than that of carburizing treatment, there has been a problem that hardening depth becomes small. Further, nitrogen is an austenite-stabilizing element, and lowers an Ms point in the same way as C, thus, retained austenite tends to be present, and there has also been a problem that it is difficult to obtain hard martensite.

Consequently, techniques solving the above-described problems in carbonitriding are disclosed in the Patent Documents 1 to 4, for example.

Specifically, the Patent Document 1 discloses a method for producing a gear with a surface-hardened microstructure where using a case hardening steel for machine structural use as a material, the C content of the outermost surface is not less than 0.5 weight % to not more than 0.9 weight %, and the N content of the outermost surface is not less than 0.3 weight % to not more than 0.8 weight %, the N content is set to almost the same as the C content, and the penetration depth of N reaches at least 80% depth of an effective hardening depth being a depth capable of obtaining hardness 550 of Hv, which is a method for producing a gear excellent in tooth surface strength characterized in that carburizing treatment and nitriding treatment are simultaneously conducted at a temperature of not less than 800° C. to not more than 950° C. to a gear material made of a case hardening steel for machine structural use, then cooled, further, reheated up to an austenitizing temperature of not less than 800° C. to not more than 930° C. to conduct nitriding treatment again, then, hardened, and the surface-hardened microstructure includes a dense martensitic microstructure in which not only C but also N is dissolved.

The Patent Document 2 discloses a high-strength gear characterized in that as a material, using a case hardening steel for machine structural use where C, Si, Mn, P, S, Cr are added as a chemical component, or further Mo or Mo and V are added to these components, a gear-form material is subjected to carbonitriding treatment, and this treatment is a surface hardening heat treatment where a carburizing process, a nitriding process with NH₃ gas, an immersion process in a salt, and a tempering process are carried out in this order, and the nitrogen content to at least 150 μm depth from the surface is not less than 0.2% and not more than 0.8%, and has a surface-hardened layer including a mixed microstructure of dense martensite containing nitrogen and the retained austenite of 10 to 40%, or a mixed microstructure of dense martensite containing nitrogen, lower bainite, and the retained austenite of 10 to 40%.

The Patent Document 3 discloses a heat treatment method of carbonitrided part excellent in pitting resistance characterized in that in weight % (same in all cases), a part of steel containing C: 0.10 to 0.35%, Si: 0.05 to 1.00%, Mn: 0.30 to 1.50%, S: 0.005 to 0.03%, Cr: 0.50 to 4.00%, and Al: 0.02 to 0.60%, according to need, containing one kind, two kinds or more of Ni: 0.05 to 3.00%, Mo: 0.05 to 4.00%, V: 0.05 to 1.00% and W: 0.05 to 0.100%, further, according to need, containing Nb: 0.005 to 0.10%, with the balance being substantially Fe, is carbonitrided after carburizing, or carbonitrided, and then hardened, and tempered at a temperature of 200 to 560° C. Here, “pitting resistance” is the same meaning as “pitting strength” in the present invention.

The Patent Document 4 discloses a steel for carbonitriding use applied to a polishing component excellent in abrasion strength and rolling contact fatigue characteristic, where the contents of alloy elements are, in mass %, C: 0.10 to 0.30%, Si: 0.50 to 1.50%, Mn: 0.50 to 1.50%, P: ≦0.020%, S: 0.003 to 0.020%, Cr: 0.50 to 3.00%, with the balance being Fe and impurities.

### CITATION LIST

### Patent Document

Patent Document 1: JP 11-51155 A
Patent Document 2: JP 7-190173 A
Patent Document 3: JP 2001-140020 A
Patent Document 4: JP 2002-194492 A

### SUMMARY OF THE INVENTION

### Problems to be Solved by the Invention

In the case of the process for producing a gear disclosed in the foregoing Patent Document 1, for the effective hardening depth to become large by deepening the penetration depth of nitrogen, it is necessary to conduct reheat hardening. Hence, the technique disclosed in the Patent Document 1 is not efficient from the points of production process and energy consumption.

The high-strength gear disclosed in the Patent Document 2 relates to a technique that so as to be a microstructure mainly of dense martensite containing nitrogen, or dense martensite containing nitrogen and lower bainite, the amount of retained austenite is simply limited to 10 to 40%. Hence, the technique disclosed in the Patent Document 2 has not necessarily obtained a sufficient abrasion strength and pitting strength.

The heat treatment method disclosed in the Patent Document 3 is based on the technical idea that by tempering at a temperature of 200 to 560° C. which is higher than conventional 150 to 180° C., soft retained austenite is decomposed into martensite and η-carbide, in addition to that surface hardness can be enhanced, nitrides such as CrN and AlN are finely precipitated and precipitation-hardened, thereby improving pitting resistance. In tempering at the above-described temperature range of 200 to 560° C., for being decomposed into a mixed microstructure of martensite capable of enhancing surface hardness and η-carbide, it is important to control the nitrogen concentration in the original retained austenite. Nevertheless, since the Patent Document 3 does not disclose at all how much nitrogen should be introduced in the carbonitriding process, namely, the most suitable nitrogen potential, there has been a case that the above-described mixed microstructure is not obtained at all depending on chosen nitrogen potential. In addition, when tempering is conducted at a high temperature side in the designated temperature range even causing precipitation of alloy element nitrides such as CrN and AlN, the retained austenite is decomposed not into martensite and η-carbide, but into ferrite and cementite, or coarse γ′-Fe₄N nitride precipitate to lower the hardness greatly, and there has been a problem that pitting strength rather becomes low.

The steel for carbonitriding disclosed in the Patent Document 4 is based on the technical idea that temper softening strength is enhanced by increasing the content of Si. However, in the case of just applying a common gas carbonitriding treatment without controlling a carbonitriding atmosphere, since the content of Si is high, an acceleration of intergranular oxidation cannot be avoided; and therefore, there has been a problem that no sufficient surface hardness can be obtained.

As described above, according to the carbonitriding techniques proposed so far, it has been insufficient to provide a carbonitrided part excellent in both abrasion strength and pitting strength efficiently.

An objective of the present invention is to provide a carbonitrided part capable of solving these problems and in addition, ensuring the excellent abrasion strength and large pitting strength in spite of being less expensive than the conventional steel by reducing or omitting the content of Mo, an expensive alloy element whose price has been soared in recent years. Another objective of the present invention is to provide a process for producing carbonitrided part capable of obtaining the above-described carbonitrided part efficiently.

### Means for Solving the Problems

In order to solve the foregoing problems, the present inventors carried out carbonitriding experiments by various conditions using case hardening steels of chromium type typified by SCr420 and chromium molybdenum type typified by SCM420, and studied the relationship between the abrasion strength/pitting strength of a carbonitrided part, and the microstructure of a surface hardened layer.

As a result, with regard to the microstructure capable of exhibiting the excellent abrasion strength and pitting strength in carbonitriding, the following findings (a) to (d) were obtained.

(a) By carbonitriding and quenching, retained austenite tends to occur in a hardened layer. It has been conventionally known that retained austenite containing nitrogen is more stable and not easily transformed than retained austenite not containing nitrogen, and the smaller the volume fraction of retained austenite in the hardened layer, the better abrasion strength and larger pitting strength can be obtained.

(b) In a process for introducing nitrogen in carbonitriding, by limiting the temperature and nitrogen potential to a suitable range, it is possible to precipitate particles of ε-Fe₃N and/or ζ-Fe₂N with a size along a major axis of 50 to 300 nm. These iron nitride particles are stably present in the hardened layer without changes even when they are quenched after carbonitriding, and further, tempered thereafter, contributing to an increase in the surface layer hardness of carbonitrided parts, particularly, having an effect of improving the abrasion strength. The above-described iron nitride particles also have an effect of improving the pitting strength of carbonitrided part.

(c) The retained austenite formed in the hardened layer by quenching after carbonitriding is hardly decomposed in the common tempering conditions at 150 to 180° C. for 1 to 2 hours. However, in the temperature range of more than 250° C. and not more than 350° C., when it is tempered for 1 to 2 hours, the retained austenite is decomposed into bainitic ferrite in a fine “bamboo leaf” shape about 50 to 200 nm width and about 200 nm to 1 μm length, Fe₃C, and α″-Fe₁₆N₂, and then, the area ratio of the retained austenite lowers to less than 5%. Such decomposition behavior of the retained austenite is thought to be an isothermal bainite transformation when inferred from the shape of ferrite. At this time, hardness increases greatly, and the abrasion strength and pitting strength of carbonitrided part are improved. In the case that the tempering temperature exceeds 350° C., the retained austenite is decomposed into ferrite, Fe₃C, and γ′-Fe₄N, and the hardness in this time does not increase largely. Meanwhile, in this case, the region already transformed to martensite by a quenching treatment is decomposed into ferrite of an equiaxed grain shape and granular Fe₃C, thus, the hardness as a whole lowers. Hence, when the tempering temperature exceeds 350° C., the abrasion strength and pitting strength of carbonitrided part are lowered.

(d) When the microstructure of carbonitrided part is such one that in the hardened layer, above all, in the region up to a position of effective hardening depth defined as a depth from the surface where Vickers hardness 550 is obtained, iron nitride particles of ε-Fe₃N and/or ζ-Fe₂N with a size along a major axis of about 50 to 300 nm are dispersed, and the retained austenite is decomposed into fine bainitic ferrite about 50 to 200 nm width and about 200 nm to 1 μm length, Fe₃C, and α″-Fe₁₆N₂, even when a chromium type case hardening steel is used as a material, the carbonitrided part has the abrasion strength and pitting strength with the equivalent level or more than a part that a chromium molybdenum type case hardening steel as a material is hardened after an ordinal gas-carburizing and tempered.

The present invention has been accomplished on the basis of the above-described findings. The main points of the present invention are carbonitrided parts shown in the following (1) and (2), and processes for producing the carbonitrided part shown in the following (3) and (4).

(1) A carbonitrided part, characterized in that:

a base steel of the carbonitrided part comprises, in mass percent, C: 0.10 to 0.35%, Si: 0.15 to 1.0%, Mn: 0.30 to 1.0%, Cr: 0.40 to 2.0%, S: 0.05% or less, with the balance being Fe and impurities;

in the region from the surface of a hardened layer of the carbonitrided part to a position of effective hardening depth thereof, iron nitride particles of ε-Fe₃N and/or ζ-Fe₂N are dispersed, and retained austenite is decomposed into bainitic ferrite, Fe₃C, and α″-Fe₁₆N₂.

(2) The carbonitrided part according to the above (1), characterized in that the base steel further contains, in mass percent, Mo: 0.50% or less in lieu of a part of Fe.

(3) A process for producing a carbonitrided part, comprising the steps of:

preparing a base steel part, having a composition comprising, in mass percent, C: 0.10 to 0.35%, Si: 0.15 to 1.0%, Mn: 0.30 to 1.0%, Cr: 0.40 to 2.0%, S: 0.05% or less, with the balance being Fe and impurities;

performing treatments including the following steps 1 to 4 in sequence:

Step 1: Carburizing the base steel part under a carburizing atmosphere at a temperature of 900 to 950° C.;

Step 2: Carbonitriding the base steel part carburized according to step 1 under a carbonitriding atmosphere at a temperature of 800 to 900° C. with a nitrogen potential of 0.2 to 0.6%;

Step 3: Quenching the base steel part carbonitrided according to step 2;

Step 4: Tempering the base steel part quenched according to step 3 at a temperature of more than 250° C. to not more than 350° C.

(4) The process for producing a carbonitrided part according to the above (3), characterized in that the base steel further contains, in mass percent, Mo: 0.50% or less in lieu of a part of Fe.

Here, “effective hardening depth” indicates a depth from the surface where Vickers hardness 550 is obtained.

The ε-Fe₃N, ζ-Fe₂N, α″-Fe₁₆N₂, and γ′-Fe₄N have their own crystal structures and their lattice constants are shown in Table 1, and each phase can be identified by taking electron diffraction figures and analyzing them.

TABLE 1

| Compound | Crystal structure | Lattice const. (nm) | Source |
|---|---|---|---|
| Fe | Cubic (bcc) | a = 0.287 | a) |
| α″-Fe16N2 | Tetragonal | a = 0.629 | b) |
| | | c = 0.572 | |
| γ′-Fe4N | Cubic (fcc) | a = 0.380 | c) |
| ε-Fe3N | Hexagonal | a = 0.470 | d) |
| | | c = 0.438 | |
| ζ-Fe2N | Orthorhombic | a = 0.444 | e) |
| | | b = 0.554 | |
| | | c = 0.484 | |

<source>
a) ASTM card 6-0696
b) H. Tanaka, S. Nagakura, Y. Nakamura and Y. Hirotsu, Acta mater., 45(1997)1401, “Electron crystallography study of tempered iron-nitrogen martensite and structure refinement of precipitated α″-Fe16N2”
c) ASTM card 6-0627
d) ASTM card 49-1663
e) ASTM card 50-958

### Effects of the Invention

The carbonitrided part of the present invention has excellent abrasion strength and high pitting strength. Hence, in order to realize weight saving of a car directly linked to the improvement of energy efficiency, the said carbonitrided part can be used in power transmission components such as gear for a transmission and pulley for a belt-type continuously variable transmission of a car requiring more miniaturization and higher strength. In addition thereto, the carbonitrided part of the present invention can be produced by a method of the present invention, and a material of the carbonitrided part is a low-cost steel with less content of Mo of an expensive alloy element or without addition of Mo. Thus, it is possible to realize the reduction of production costs in comparison with the conventional power transmission components.

### BRIEF DESCRIPTION OF THE DRAWINGS

FIG. 1 is a figure showing a picture where using steel 3 used in EXAMPLE as a material; iron nitride particles present in the retained austenite produced at a position of 70 μm depth from the surface of the sample of as-oil-quenched condition after carbonitriding were observed with a transmission electron microscope. In this figure, the ones enclosed with circles are iron nitride particles.

FIG. 2 is a diagram schematically explaining one example of a “carburizing” process, “carbonitriding” process, and “quenching” process after carbonitriding in the present invention. In this diagram, the “quenching” process was exemplified as an “oil quenching” process. “Cp” and “Np” in the diagram represent carbon potential and nitrogen potential, respectively.

FIGS. 3A and 3B are figures showing pictures where using steel 3 used in EXAMPLE as a material; the microstructure of as-oil-quenched condition after carbonitriding (FIG. 3A), and the microstructure of tempered for 1 hour at 300° C. after oil-quenching (FIG. 3B) at a position of 70 μm depth from the surface of a carbonitrided part were observed respectively with a transmission electron microscope. In the FIG. 3A “retained austenite” is shown by “γ_{R}”.

FIG. 4 is a diagram showing the shape of a small roller test piece used in a roller pitting test in EXAMPLE. The unit of size is mm.

FIG. 5 is a diagram showing the shape of a block test piece used in a block on ring test in EXAMPLE. The unit of size is mm.

FIG. 6 is a diagram showing the shape of a test piece for chip sampling used for nitrogen concentration measurement in EXAMPLE. The unit of size is mm.

FIG. 7 is a diagram schematically explaining the condition of a “carburizing” process, “carbonitriding” process, “quenching” process after carbonitriding, and “tempering” process after quenching conducted in EXAMPLE. “Cp” and “Np” in the diagram represent carbon potential and nitrogen potential, respectively. In the diagram, standing to cool in atmosphere is expressed as “air cooling.”

FIG. 8 is a diagram schematically explaining a method of block on ring test conducted in EXAMPLE and the width of abrasion scar incurred on the contact face of a block test piece.

### MODES FOR CARRYING OUT THE INVENTION

In the following, the reasons for restricting the contents of the component elements of the base steel, microstructures and production conditions in the present invention are described in detail. In the following description, the symbol “%” for the content of each element means “% by mass”.

(A) Chemical Composition of the Base Steel

C: 0.10 to 0.35%

C is the most important element for determining the strength of steels, and it is necessary to contain C of 0.10% or more for ensuring the strength of base steel, that is, the strength of a core part not hardened by quenching after carbonitriding. On the other hand, when the content of C exceeds 0.35%, toughness of the core part lowers or machinability deteriorates. Therefore, the content of C is set to 0.10 to 0.35%. Additionally, the lower limit of the C content is preferably 0.20%, and the upper limit thereof is preferably 0.30%.

Si: 0.15 to 1.0%

Si is an element which has an effect of suppressing the precipitation of cementite and increasing the temper softening strength, and also contributes to an increase in strength of a core part as a solid solution hardening element. Si also has an ability to suppress the transformation of austenite into pearlite. These effects can be obtained when the content of Si is 0.15% or more. However, when the content of Si becomes large, the lowering of carburizing rate or the lowering of toughness occurs, in particular, when the content of Si exceeds 1.0%, hot workability deteriorates and also carburizing rate lowers markedly. Therefore, the content of Si is set to 0.15 to 1.0%. Additionally, the lower limit of the Si content is preferably 0.20%, and the upper limit thereof is preferably 0.90%.

Mn: 0.30 to 1.0%

Mn is an austenite stabilizing element, and an element which lowers the activity of C in austenite and accelerates carburizing. Mn forms MnS together with 5, and MnS has an ability to enhance machinability. In order to obtain these effects, it is necessary to contain Mn of 0.30% or more. However, even when Mn is contained more than 1.0%, the said effects are saturated and the cost runs up, besides, machinability may deteriorates. Therefore, the content of Mn is set to 0.30 to 1.0%. Additionally, the lower limit of the Mn content is preferably 0.50%, and the upper limit thereof is preferably 0.90%.

Cr: 0.40 to 2.0%

Cr has a large affinity to carbon and nitrogen, lowers the activities of C and N in austenite in carbonitriding, and has an effect of accelerating carbonitriding. Cr also has an effect of increasing the strength of a core part not hardened by quenching after carbonitriding through solid solution strengthening. These effects are obtained when the content of Cr is 0.40% or more. However, when the content of Cr becomes large, Cr carbides and Cr nitrides are produced at the grain boundaries, so that Cr atoms are lacking in the vicinity of grain boundaries. As a result, in the surface layer of a part, an incompletely hardened structure and/or abnormal oxidation layer tends to be formed, causing the deterioration of pitting strength and abrasion strength. In particular, when the content of Cr exceeds 2.0%, by the formation of the incompletely hardened structure in the surface layer of a part and/or abnormal layer due to intergranular oxidation, the deterioration of pitting strength and abrasion strength becomes remarkable. Therefore, the content of Cr is set to 0.40 to 2.0%. Additionally, the lower limit of the Cr content is preferably 0.50%, and the upper limit thereof is preferably 1.80%.

S: 0.05% or Less

S is an element ordinarily included as an impurity element, and as described above, it forms MnS together with Mn and MnS has an ability to enhance machinability. In order to obtain the said effect, the content of S is preferably set to 0.01% or more. On the other hand, when the content of S becomes excessive, particularly, exceeds 0.05%, hot ductility lowers and cracking tends to occur in the time of forging. Therefore, the content of S is set to 0.05% or less. Additionally, the upper limit of the S content is preferably 0.03%.

One chemical composition of base steels in the present invention is the one with the balance being Fe and impurities other than the above-described elements. Another chemical composition of base steels in the present invention is the one that further contains Mo of the following amount in addition to the above-described elements. The term “impurities” so referred to in the phrase “the balance being Fe and impurities” indicates those impurities which come from ores and scraps as raw materials, environments, and so on in the industrial production of Fe based materials, that is to say, iron and steels.

Mo: 0.50% or Less

Mo has an effect of suppressing the formation of incompletely hardened structure in the surface layer of a part and/or abnormal layer due to intergranular oxidation, and also has an effect of enhancing the hardness of a core part. Thus in order to obtain these effects, the carbonitrided part may contain Mo. However, when the content of Mo exceeds 0.50%, not only the cost of the base steel runs up but also the machinability deteriorates remarkably. Therefore, in the case of being contained, the amount of Mo is set to 0.50% or less. Additionally, the upper limit of the Mo content is preferably set to 0.30%. On the other hand, in order to surely obtain the foregoing effect by Mo of suppressing the formation of incompletely hardened structure in the surface layer of a part and/or abnormal layer due to intergranular oxidation and further, an effect of enhancing the hardness of a core part, the lower limit of the Mo content is preferably set to 0.05%, and more preferably set to 0.10%.

Additionally, with regard to impurities in the chemical composition of the base steel in the present invention, in particular, the content of P is preferably limited to 0.05% or less, and more preferably limited to 0.03% or less.

(B) Microstructure

The carbonitrided part of the present invention must have a microstructure where in the region up to a position of effective hardening depth from the surface of a hardened layer, iron nitride particles of ε-Fe₃N and/or ζ-Fe₂N are dispersed, and retained austenite is decomposed into bainitic ferrite, Fe₃C, and α″-Fe₁₆N₂. This is detailed below.

First, in the case of carbonitriding, in the surface layer region of a part to become a hardened layer by quenching after carbonitriding, particles of ε-Fe₃N and/or ζ-Fe₂N being iron nitrides are precipitated and dispersed, these iron nitrides do not change even when they are quenched after carbonitriding, and even tempered after the quenching; and thus, surface layer hardness of the carbonitrided part increases, abrasion strength is improved, and also pitting strength becomes high. Additionally, even when the surface layer hardness is in the equivalent level, in the case that the above-described iron nitride particles are dispersed in the hardened layer, above all, in the case of being dispersed in the region up to a position of effective hardening depth from the surface of a hardened layer, it is possible for the carbonitrided part to ensure a very good abrasion strength by a so-called “dispersion strengthening” effect, in addition to the high hardness of the iron nitride partials themselves.

Additionally, it is preferable that the iron nitride particles of ε-Fe₃N and/or ζ-Fe₂N dispersed in the region up to a position of effective hardening depth from the surface of the hardened layer are several tens to several hundreds nm in size along their major axis, particularly 50 to 300 nm. These iron nitrides are observed, for example, with a transmission electron microscope, hereinafter called “TEM,” by preparing a thin film sample, and the size thereof can be confirmed. By photographing an electron diffraction pattern from the region including these iron nitrides, and analyzing the diffraction pattern to obtain the crystal structure and lattice constant, thereby, which is ε-Fe₃N or ζ-Fe₂N can be identified.

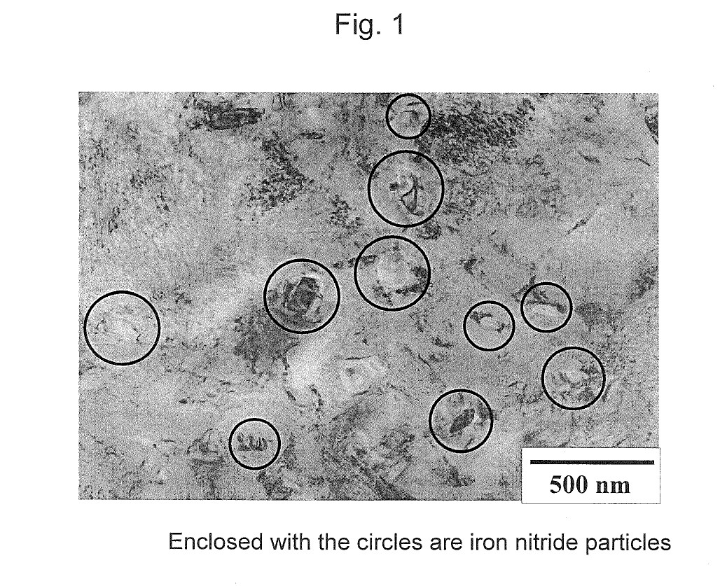

Additionally, in FIG. 1, as one example of the iron nitride particles of ε-Fe₃N and/or ζ-Fe₂N dispersed in the region up to a position of effective hardening depth from the surface of the hardened layer, the case of using steel 3 denoted in the following EXAMPLE is shown. FIG. 1 is a picture where a thin film sample was observed with a TEM to show iron nitride particles embedded in the retained austenite formed at a position of 70 μm depth from the surface of the sample of as-oil-quenched condition after carbonitriding. In this figure, the ones enclosed with circles are iron nitride particles.

Next, when the retained austenite formed in the hardened layer by quenching after carbonitriding is decomposed into bainitic ferrite, Fe₃C, and α″-Fe₁₆N₂ by tempering, the surface layer hardness of the carbonitrided part increases remarkably, being combined with a beneficial effect of the foregoing iron nitride particles of ε-Fe₃N and/or ζ-Fe₂N originally present, the abrasion strength and pitting strength are improved extremely.

That is to say, when the retained austenite including carbon and nitrogen formed in a hardened layer by quenching after carbonitriding is decomposed by tempering, if γ′-Fe₄N being a stable phase of iron nitride is formed, hardness lowers, but if α″-Fe₁₆N₂ being a metastable phase of iron nitride is formed, hardness increases.

With regard to the decomposition of the above-described retained austenite, for example, the shape and size of a phase can be confirmed by preparing a thin film sample and observing it with a TEM, and each phase can be identified by photographing an electron diffraction pattern under a selected area including a specific phase and analyzing this.

From the above, regarding the carbonitrided part of the present invention, it is regulated that in the region up to a position of effective hardening depth from the surface of a hardened layer, iron nitride particle of ε-Fe₃N and/or ζ-Fe₂N are dispersed, and retained austenite is decomposed into bainitic ferrite, Fe₃C, and α″-Fe₁₆N₂.

Additionally, the microstructure described in this (B) section can be obtained by subjecting steel product having a chemical composition described in the foregoing (A) section to a heat treatment of the condition described in the next (C) section.

(C) Production Condition

The heat treatment in a production process of the present invention includes a “carburizing” process for maintaining under a carburizing atmosphere of 900 to 950° C., following this carburizing, a “carbonitriding” process for lowering the temperature to 800 to 900° C., while the carburizing atmosphere is maintained, for maintaining under an atmosphere that nitrogen potential is 0.2 to 0.6% being also provided with a nitriding property by mixing ammonia gas or the like, for example, then, a “quenching” process after carbonitriding, and a “tempering” process in the temperature range of more than 250° C. to not more than 350° C.

The carburizing capability and nitriding capability of an atmosphere are defined as carbon potential and nitrogen potential, respectively. That is to say, they are expressed as carbon concentration and nitrogen concentration of the surface of a treated part when equilibrated to the atmosphere at a specific atmosphere temperature. The carbon concentration profile and nitrogen concentration profile to the depth direction from the surface of a treated part are determined by the carbon potential, nitrogen potential, treating temperature, and treating time. In this regard, in the present invention, as the following EXAMPLE, “nitrogen potential” is defined as an average concentration of nitrogen up to a position of 50 μm from the outermost surface of a treated part when equilibrated to the atmosphere at a specific atmosphere temperature. This is because the chip when a peripherally-curved part of a cylindrical sample of 30 mm in diameter and 50 mm in height as a treated part is cut out by 50 μm depth toward the center along the radial direction from the outermost surface is subjected to a chemical analysis to obtain the nitrogen concentration, and the concentration was defined as “surface nitrogen concentration.”

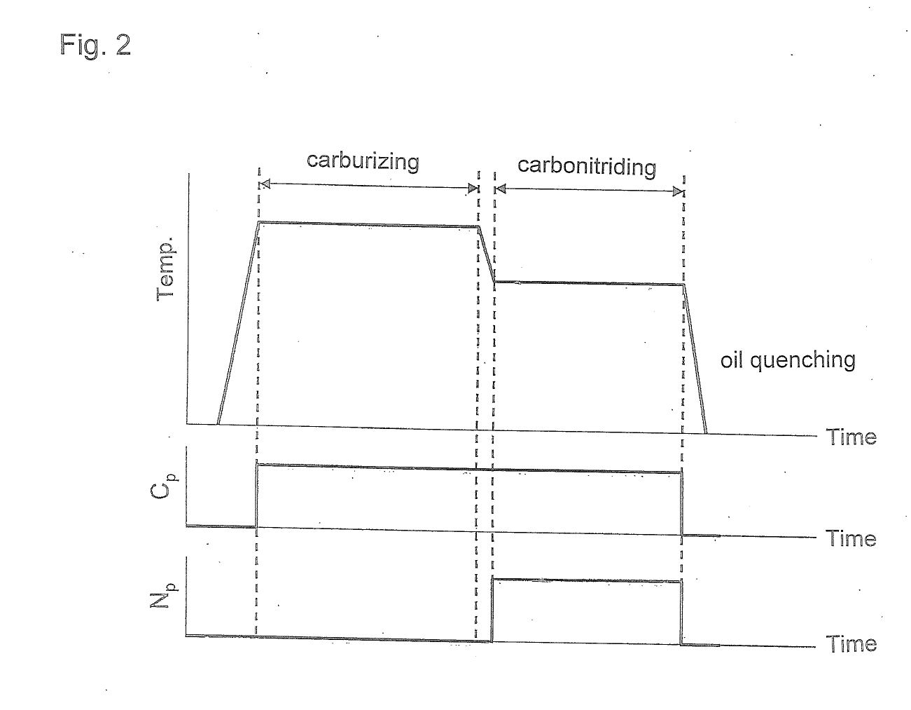

FIG. 2 is a diagram schematically explaining one example of a “carburizing” process, “carbonitriding” process, and “quenching” process after carbonitriding in the present invention. In this diagram, the “quenching” process was exemplified as an “oil quenching” process. “Cp” and “Np” in the figure represent carbon potential and nitrogen potential, respectively.

The carbon potential is not necessarily kept in a state shown in FIG. 2, that is to say, kept in a constant state in both carburizing and carbonitriding processes. It may be suitably varied from the viewpoints of a targeted surface carbon concentration, effective hardened layer depth, and efficient operation.

For example, by setting the carbon potential in the carburizing process to somewhat higher than a targeted surface carbon concentration of a carbonitrided part and lowering the carbon potential to a targeted surface carbon concentration in transfer to the next carbonitriding process, it is possible to shorten the total treating time of the carburizing and carbonitriding.

In the “carburizing” process, for example, there can be adopted “gas-carburizing” process using an atmosphere that a so-called “enriched gas”, such as butane and propane, is added up to an endothermic gas, which is ordinarily called “RX gas”, being a mixed gas of CO, H₂, and N₂, which are synthesized by mixing hydrocarbon gas, such as butane and propane, with air. A treating temperature in this “carburizing” process, that is to say, a temperature maintaining under the carburizing atmosphere is set to 900 to 950° C. This is because when the above-described temperature is more than 950° C., grain coarsening tends to occur and the strength after hardening tends to be lowered. On the other hand, when the said temperature is less than 900° C., a sufficient hardened layer depth becomes difficult to obtain. Although the time maintaining at the above-described temperature depends on the degree of a desired hardened layer depth, for example, it may be set to about 2 to 15 hours. The above-described carbon potential can be controlled mainly by the added amount of enriched gas.

The “carbonitriding” process following the said “carburizing” process is conducted at a temperature of 800 to 900° C. and a carbonitriding atmosphere with a nitrogen potential of 0.2 to 0.6%.

By conducting the carbonitriding with a nitrogen potential of 0.2% or more in a temperature of 800 to 900° C., about 50° C. higher than the conventionally common “carbonitriding” process, where solubility of nitrogen in austenite becomes small, ε-Fe₃N and/or ζ-Fe₂N which are iron nitride particles with several tens to several hundreds nm in size along a major axis, particularly 50 to 300 nm can be precipitated and dispersed. By conducting the carbonitriding with a nitrogen potential of 0.2% or more, austenite is stabilized and the retained austenite can be easily obtained. When the nitrogen potential is less than 0.2%, neither ε-Fe₃N nor ζ-Fe₂N which is an iron nitride particle with several tens to several hundreds nm in size along a major axis, particularly 50 to 300 nm, can be precipitated and dispersed and incompletely hardened structure other than the retained austenite and martensite may be formed. In this regard, when the nitrogen potential is too large, particularly more than 0.6%, the above-described iron nitride particles tend to grow coarser, the size along a major axis exceeds 300 nm, and it becomes difficult to obtain dispersion strengthening by iron nitride particles. Hence, the nitrogen potential in the above-described temperature range must be 0.6% or less.

The above-described “carbonitriding” process may be conducted, for example, by adding ammonia gas after lowering the temperature inside a furnace to 800 to 900° C. which is a carbonitriding temperature while the gas atmosphere of the carburizing process is kept. The nitrogen potential in this case can be controlled by the added amount of ammonia gas. The holding time to maintain under the above-described carbonitriding atmosphere may be set to 1 to 2 hours for example.

The “quenching” process after carbonitriding may adopt an oil-quenching process as exemplified in FIG. 2.

Since nitrogen dissolves into austenite in the carbonitriding process, austenite is stabilized, and even when this is cooled rapidly by oil-quenching, austenite not transformed to martensite, that is to say, retained austenite tends to be formed. This retained austenite lowers the surface layer hardness of a carbonitrided part; and therefore, pitting strength deteriorates. Hence, conventionally, the formation of retained austenite is avoided by changing the oil-quenching conditions, or a subzero treatment is conducted after oil-quenching to transform the produced retained austenite into martensite, then, tempering is conducted at a low temperature of about 150 to 180° C. after quenching. However, in the case of conducting the carbonitriding under the foregoing conditions, it is not necessary to control the amount of the retained austenite by changing the quenching conditions or conducting a subzero treatment. After the said “quenching” process, only tempering may be conducted in the temperature range of more than 250° C. to not more than 350° C.

The retained austenite where the foregoing iron nitride particles of ε-Fe₃N and/or ζ-Fe₂N with several tens to several hundreds nm in size along a major axis, particularly 50 to 300 nm were dispersed is hardly decomposed even by tempering at 250° C. or less for 1 to 2 hours. However, when it is tempered in the temperature range of more than 250° C. to not more than 350° C. being maintained for 1 to 2 hours, an isothermal bainite transformation occurs, the retained austenite is decomposed into fine bainitic ferrite about 50 to 200 nm width and about 200 nm to 1 μm length, Fe₃C, and α″-Fe₁₆N₂. Hardness increases remarkably by this decomposition of the retained austenite, and the iron nitride particles of ε-Fe₃N and/or ζ-Fe₂N with several tens to several hundreds nm in size along a major axis present before tempering are not changed by this tempering. Thus, by a synergetic effect with the beneficial effect of these iron nitride particles, the abrasion strength and pitting strength of a carbonitrided part are improved greatly.

In the case where the tempering temperature exceeds 350° C., retained austenite is decomposed into ferrite, Fe₃C, and γ′-Fe₄N, in this time, not only hardness hardly increases, but also the part transformed to martensite is decomposed into ferrite of an equiaxed grain shape and granular Fe₃C, thus hardness as a whole lowers. Hence, when the tempering temperature exceeds 350° C., the abrasion strength and pitting strength of a carbonitrided part deteriorates.

From the above reason, a process for producing the carbonitrided part of the present invention is described below: following the carburizing maintaining it under a carburizing atmosphere at 900 to 950° C., carbonitriding maintaining it under a carbonitriding atmosphere with a nitrogen potential of 0.2 to 0.6% at 800 to 900° C. is conducted. Subsequently, quenching is conducted, thereafter, further, tempering is conducted in the temperature range of more than 250° C. to not more than 350° C.

As described above, when the austenite including carbon and nitrogen produced in the carbonitriding process undergoes phase decomposition, if γ′-Fe₄N being a stable phase of iron nitride is formed, hardness lowers, but if α″-Fe₁₆N₂ being a metastable phase of iron nitride is formed, hardness increases, and the mechanism of the phase decomposition in that regard is characterized by an isothermal bainite transformation. This could be interpreted as follows.

The α″-Fe₁₆N₂ is a phase which appears when iron containing nitrogen in supersaturation is aged at low temperature, and when maintained for a long time, it undergoes transition to γ′-Fe₄N. On the other hand, when iron containing nitrogen in supersaturation is aged at high temperature, γ′-Fe₄N is formed directly. Thus, on an Fe—N phase diagram, for α″-Fe₁₆N₂ and γ′-Fe₄N, specific solubility curves can be drawn, and there are positioned a solubility curve of α″-Fe₁₆N₂ at the low temperature side, and a solubility curve of γ′-Fe₄N at the high temperature side. That is to say, it can be thought that “low temperature phase” is the α″-Fe₁₆N₂ and “high temperature phase” is the γ′-Fe₄N.

When the case that the above-described austenite including nitrogen undergoes bainite transformation is thought analogously as the case that austenite containing carbon undergoes bainite transformation, a state that α″-Fe₁₆N₂ of a “low temperature phase” occurs corresponds to the “lower bainite,” and a state that γ′-Fe₄N of a “high temperature phase” occurs corresponds to the “upper bainite.” That is to say, when the retained austenite formed by carbonitriding corresponds to a “lower bainite” structure, hardness increases, and then, the abrasion strength and pitting strength of a carbonitrided part increase.

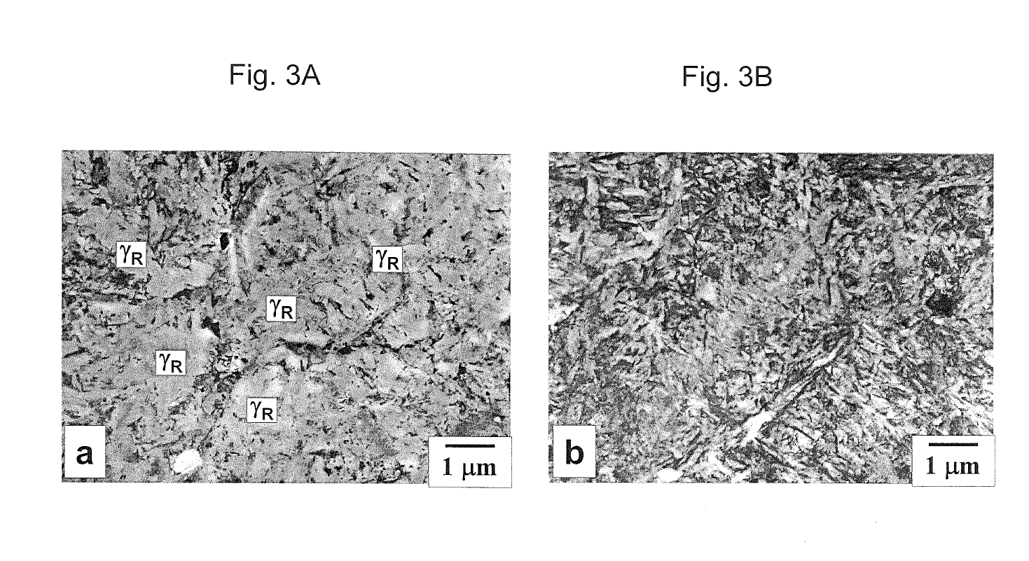

FIGS. 3A and 3B are figures showing examples of pictures where using steel 3 used in EXAMPLE as a material; the microstructure of as-oil-quenched condition after carbonitriding, and the microstructure of tempered for 1 hour at 300° C. after oil-quenching at a position of 70 μm depth from the surface of a carbonitrided part were observed, respectively. FIGS. 3A and 3B are pictures of thin film samples observed with a TEM.

FIG. 3A is a microstructure of as-oil-quenched condition, and “retained austenite” is a main constituent phase, other parts, for example, the part sandwiched by the region of retained austenite shows a lath-like structure. Judged from such shape, it is considered to be the part transformed to martensite. In this figure, “retained austenite” is shown as “γ_{R}.” FIG. 3B is a microstructure after being tempered for 1 hour at 300° C., which is the structure that the above-described retained austenite is decomposed into fine bainitic ferrite, Fe₃C, and α″-Fe₁₆N₂, and this is known to be similar to the “lower bainite” structure of the Fe—C type.

In the following explanation, the microstructure shown in FIG. 3B which is similar to the “lower bainite” structure of the Fe—C type, that is to say, such a mixed structure that the retained austenite is decomposed into bainitic ferrite, Fe₃C, and α″-Fe₁₆N₂ is referred to as the “lath-like bainite” for the sake of convenience.

Hereinafter, the present invention is explained further in detail by Example.

### Example

Steels 1 to 5 having the chemical compositions shown in Table 2 were melted by using a 50 kg vacuum melting furnace and cast to form ingots.

The above-described steels 1 to 5 are steels having chemical compositions falling within the range regulated by the present invention; and steel 1 is a steel corresponding to the SCr420 specified in JIS G 4053 (2003). Steels 2 to 4 are steels enriched in Si content, Cr content, Si and Cr contents among elements of the SCr420, respectively. Steel 5 is a steel containing Mo in the SCr420, and it is a steel corresponding to the SCM420 specified in the above-described JIS. Additionally, with regard to all steels, as impurities, the content of Ni was 0.02% and the content of Cu was 0.02%.

TABLE 2

| | Chemical composition (% by mass) | | | | | | | |
|---|---|---|---|---|---|---|---|---|
| | Balance: Fe and impurities | | | | | | | |
| Steel | C | Si | Mn | P | S | Cr | Mo | Note |
| 1 | 0.22 | 0.25 | 0.80 | 0.019 | 0.012 | 1.00 | — | (a) |
| 2 | 0.24 | 0.80 | 0.86 | 0.016 | 0.015 | 1.10 | — | |
| 3 | 0.24 | 0.20 | 0.86 | 0.015 | 0.015 | 1.80 | — | |
| 4 | 0.23 | 0.80 | 0.84 | 0.016 | 0.015 | 1.80 | — | |
| 5 | 0.22 | 0.25 | 0.83 | 0.015 | 0.015 | 1.13 | 0.16 | (b) |

Note:
(a) Steel corresponding to the SCr420
(b) Steel corresponding to the SCM420

Thus the obtained ingot was heated to 1250° C., and then was hot forged so that the finish temperature was 1000° C. to form a round bar having a diameter of 35 mm. After completion of hot forging, it was stood to cool in atmosphere.

Next, the round bar of 35 mm in diameter was subjected to a normalizing treatment where it was heated to 925° C. and held at the said temperature for 120 minutes, then stood to cool in the atmosphere, yielding a mixed microstructure of ferrite and pearlite.

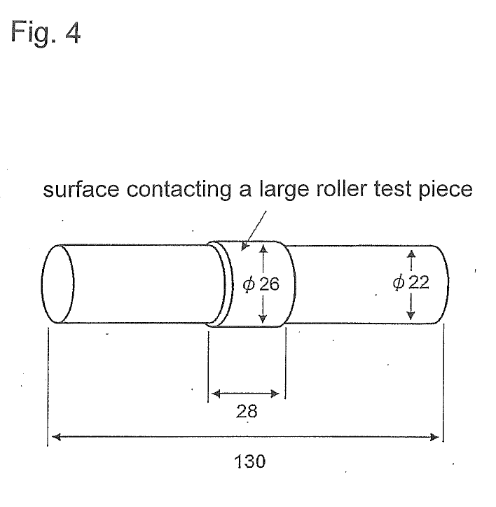

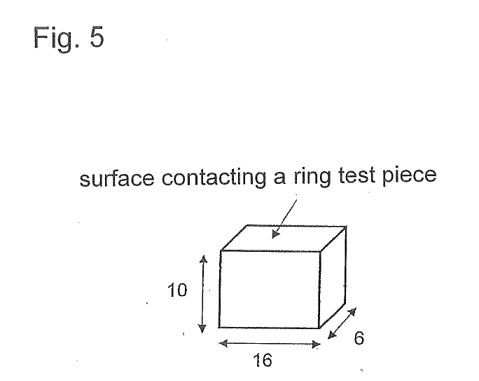

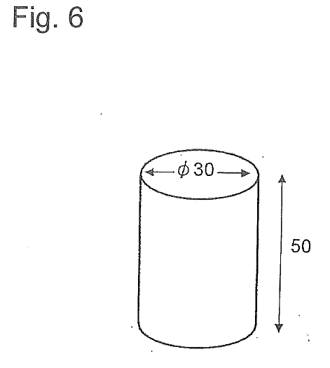

From the center part of each normalized round bar of 35 mm in diameter, in parallel to the forging direction, i.e. forge axis, the following test pieces for various evaluations were cut out. A small roller test piece is shown in FIG. 4 for a roller pitting test, i.e. two cylinder rolling fatigue test, a block test piece is shown in FIG. 5, and a test piece for chip sampling is shown in FIG. 6. The block test piece shown in FIG. 5 was used in a block on ring abrasion test, microstructure observation, and hardness measurement. The units of test pieces shown in FIG. 4 to 6 are all “mm.”

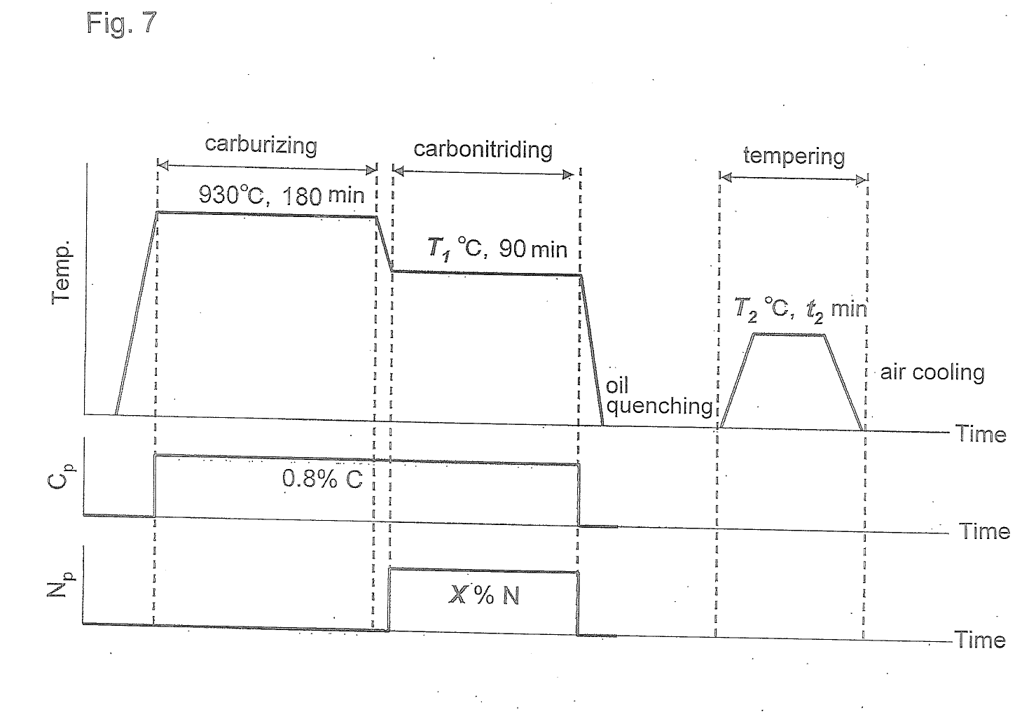

The test piece for chip sampling was, in a state as it was cut out, subjected to carburizing, carbonitriding, and oil quenching under the heat treatment condition schematically shown in FIG. 7, then, tempering was conducted. Regarding the small roller test piece for a roller pitting test and the block test piece, as shown in FIG. 4 and FIG. 5, respectively, surfaces contacting a large roller test piece and a ring test piece were machined, then, heat treatment was conducted in the condition schematically shown in the FIG. 7.

In the carburizing process, the temperature was 930° C., holding time was 180 minutes, and carbon potential was kept constant at 0.8%.

In the carbonitriding process, the carbon potential was kept constant at 0.8% being the same as in the carburizing process, and the holding time was kept constant for 90 minutes, and holding temperature T₁° C. and nitrogen potential were changed variously. In this case, the nitrogen potential was adjusted by changing the flow rate of ammonia gas introduced to a furnace. Additionally, each steel was treated as well practically under the same condition as the gas carburization without flowing ammonia gas to a furnace in the carbonitriding process in the heat treatment condition of FIG. 7.

The nitrogen potential was measured using a test piece for chip sampling which was oil-quenched after carbonitriding. That is to say, the curved part of a cylindrical sample of 30 mm in diameter and 50 mm in height shown in FIG. 6 was lathed off by 50 μm toward the center direction from the outermost circumference, and the chip thus sampled was analyzed under helium gas atmosphere by an analyzer Leco TC-136 based on fusion-thermal conductivity method, and the concentration of nitrogen obtained by this analysis was defined as “nitrogen potential.” For the test pieces treated practically in the same condition as the gas-carburizing without flowing ammonia gas to a furnace in the carbonitriding process, the above-described analytical examination of “nitrogen potential” was not conducted.

In the tempering process, after the treatment by varying holding temperature T₂° C. and holding time t₂ min variously, the sample was taken out and stood to cool in the atmosphere. In FIG. 7, the standing to cool in the atmosphere was expressed as the “air cooling.”

In Tables 3 and 4, for each steel, the details of holding temperature T₁° C. and nitrogen potential in the above-described carbonitriding process, holding temperature T₂° C. and holding time t₂ min in the tempering process are shown. In Tables 3 and 4, nitrogen potential was expressed as “Np.”

TABLE 3

| | | Carbonitridung | | Tempering | |
|---|---|---|---|---|---|
| | Test | Temp. T₁ | Np | Temp. T₂ | Time t₂ |
| Steel | mark | (° C.) | (%) | (° C.) | (min) |
| 1 | 1-a | 850 | 0.55 | 300 | 60 |
| | 1-b | 850 | 0.55 | 340 | 60 |
| | 1-c | 850 | 0.55 | 260 | 120 |
| | 1-d | 850 | 0.45 | 300 | 60 |
| | 1-e | 850 | 0.32 | 300 | 60 |
| | 1-f | 850 | 0.24 | 300 | 60 |
| | 1-g | 850 | 0.24 | 340 | 60 |
| | 1-h | 850 | 0.24 | 260 | 120 |
| | 1-i | 900 | 0.20 | 300 | 60 |
| | 1-j | 800 | 0.60 | 300 | 60 |
| | 1-p | 850 | * 0.12 | 300 | 60 |
| | 1-q | 850 | 0.55 | * 180 | 120 |
| | 1-r | 850 | 0.55 | * 400 | 60 |
| | 1-s | 900 | * 0.10 | 300 | 60 |
| | 1-t | 800 | * 0.14 | 300 | 60 |
| | 1-u | 850 | * 0.04 | * 180 | 60 |
| | 1-v | 850 | * — | * 180 | 60 |

| | | Carbonitriding | | Tempering | |
|---|---|---|---|---|---|
| | Test | Temp. T₁ | Np | Temp. T₂ | Time t₂ |
| Steel | mark | (° C.) | (%) | (° C.) | (min) |
| 2 | 2-a | 850 | 0.54 | 300 | 60 |
| | 2-b | 850 | 0.54 | 340 | 60 |
| | 2-c | 850 | 0.54 | 260 | 120 |
| | 2-d | 850 | 0.42 | 300 | 60 |
| | 2-e | 850 | 0.33 | 300 | 60 |
| | 2-f | 850 | 0.26 | 300 | 60 |
| | 2-g | 850 | 0.26 | 340 | 60 |
| | 2-h | 850 | 0.26 | 260 | 120 |
| | 2-i | 900 | 0.20 | 300 | 60 |
| | 2-j | 800 | 0.59 | 300 | 60 |
| | 2-p | 850 | * 0.11 | 300 | 60 |
| | 2-q | 850 | 0.54 | * 180 | 120 |
| | 2-r | 850 | 0.54 | * 400 | 60 |
| | 2-s | 900 | * 0.11 | 300 | 60 |
| | 2-t | 800 | * 0.13 | 300 | 60 |
| | 2-u | 850 | * 0.04 | * 180 | 60 |
| | 2-v | 850 | * — | * 180 | 60 |
| 3 | 3-a | 850 | 0.56 | 300 | 60 |
| | 3-b | 850 | 0.56 | 340 | 60 |
| | 3-c | 850 | 0.56 | 260 | 120 |
| | 3-d | 850 | 0.44 | 300 | 60 |
| | 3-e | 850 | 0.32 | 300 | 60 |
| | 3-f | 850 | 0.25 | 300 | 60 |
| | 3-g | 850 | 0.25 | 340 | 60 |
| | 3-h | 850 | 0.25 | 260 | 120 |
| | 3-i | 900 | 0.21 | 300 | 60 |
| | 3-j | 800 | 0.58 | 300 | 60 |
| | 3-p | 850 | * 0.11 | 300 | 60 |
| | 3-q | 850 | 0.56 | * 180 | 120 |
| | 3-r | 850 | 0.56 | * 400 | 60 |
| | 3-s | 900 | * 0.11 | 300 | 60 |
| | 3-t | 800 | * 0.15 | 300 | 60 |
| | 3-u | 850 | * 0.04 | * 180 | 60 |
| | 3-v | 850 | * — | * 180 | 60 |

The “Np” represents nitrogen potential and was defined as follows: The curved part of a cylindrical sample of 30 mm diameter and 50 mm height was lathed off by 50 μm toward the center direction from the outermost circumference, and the chip thus sampled was analyzed under helium gas atmosphere by an analyzer Leco TC-136 based on fusion-thermal conductivity method, and the concentration of nitrogen obtained by this analysis was defined as “Np.”
The symbol “—” in the test marks 1-v, 2-v and 3-v indicates that the above-described analytical examination of “Np” was not conducted.
The mark * indicates falling outside the conditions regulated by the present invention.

TABLE 4

| | | Carbonitriding | | Tempering | | | | Carbonitriding | | Tempering | |
|---|---|---|---|---|---|---|---|---|---|---|---|
| | Test | Temp. T₁ | Np | Temp. T₂ | Time t₂ | | Test | Temp. T₁ | Np | Temp. T₂ | Time t₂ |
| Steel | mark | (° C.) | (%) | (° C.) | (min) | Steel | mark | (° C.) | (%) | (° C.) | (min) |
| 4 | 4-a | 850 | 0.57 | 300 | 60 | 5 | 5-a | 850 | 0.56 | 300 | 60 |
| | 4-b | 850 | 0.57 | 340 | 60 | | 5-b | 850 | 0.56 | 340 | 60 |
| | 4-c | 850 | 0.57 | 260 | 120 | | 5-c | 850 | 0.56 | 260 | 120 |
| | 4-d | 850 | 0.45 | 300 | 60 | | 5-d | 850 | 0.44 | 300 | 60 |
| | 4-e | 850 | 0.31 | 300 | 60 | | 5-e | 850 | 0.32 | 300 | 60 |
| | 4-f | 850 | 0.28 | 300 | 60 | | 5-f | 850 | 0.26 | 300 | 60 |
| | 4-g | 850 | 0.28 | 340 | 60 | | 5-g | 850 | 0.26 | 340 | 60 |
| | 4-h | 850 | 0.28 | 260 | 120 | | 5-h | 850 | 0.26 | 260 | 120 |
| | 4-i | 900 | 0.20 | 300 | 60 | | 5-i | 900 | 0.22 | 300 | 60 |
| | 4-j | 800 | 0.57 | 300 | 60 | | 5-j | 800 | 0.57 | 300 | 60 |
| | 4-p | 850 | * 0.12 | 300 | 60 | | 5-p | 850 | * 0.10 | 300 | 60 |
| | 4-q | 850 | 0.57 | * 180 | 120 | | 5-q | 850 | 0.56 | * 180 | 120 |
| | 4-r | 850 | 0.57 | * 400 | 60 | | 5-r | 850 | 0.56 | * 400 | 60 |
| | 4-s | 900 | * 0.11 | 300 | 60 | | 5-s | 900 | * 0.09 | 300 | 60 |
| | 4-t | 800 | * 0.13 | 300 | 60 | | 5-t | 800 | * 0.12 | 300 | 60 |
| | 4-u | 850 | * 0.04 | * 180 | 60 | | 5-u | 850 | * 0.04 | * 180 | 60 |
| | 4-v | 850 | * — | * 180 | 60 | | 5-v | 850 | * — | * 180 | 60 |

The “Np” represents nitrogen potential and was defined as follows: The curved part of a cylindrical sample of 30 mm Diameter and 50 mm height was lathed off by 50 μm toward the center direction from the outermost circumference, and the chip thus sampled was analyzed under helium gas atmosphere by an analyzer Leco TC-136 based on fusion-thermal conductivity method, and the concentration of nitrogen obtained by this analysis was defined as “Np.”
The symbol “—” in the test marks 4-v and 5-v indicates that the above-described analytical examination of “Np” was not conducted.
The mark * indicates falling outside the conditions regulated by the present invention.

The thus produced roller test piece was examined for pitting strength by carrying out a roller pitting test in the condition shown in Table 5.

TABLE 5

| | |
|---|---|
| Size of | Small roller: 26 mm in diameter |
| test piece | Large roller: 130 mm in diameter |
| | 150 mm in crowing |
| Sliding rate | 80% |
| Rotation speed | 1000 rpm |
| of small roller | |
| Surface pressure | 2800 MPa, 3000 MPa |
| Oil lubricant | Automatic transmission oil |
| | Temperature: 40° C. |
| | Quantity: 2 litters/min |

Abrasion strength was examined by carrying out a block on ring abrasion test using a part of the block test piece under the condition shown in Table 6, and microstructure observation and hardness measurement were carried out using the rest of the block test piece.

TABLE 6

| | |
|---|---|
| Load | 1000N |
| Slip velocity | 0.1 m/s |
| Gross contact | 8000 m |
| distance | |
| Oil lubricant | Automatic transmission oil |
| | Temperature: 90° C. |

As a large roller test piece used in a roller pitting test and as a ring test piece used in a block on ring abrasion test, the following one was used: the SCM822 specified in JIS G 4053 (2003) was machined, and oil-quenched after gas-carburizing under the condition of a temperature of 930° C., holding time of 180 minutes, and carbon potential of 0.8%, subsequently, tempered at 180° C. for 120 minutes, and stood to cool in the atmosphere, then, the surface layer was ground by 50 μm.

The roller pitting test was conducted till surface removal due to fatigue occurred, or in the case of no occurrence of this fatigue removal, the test was continued till the accumulated rotation cycle reached 2.0×10⁷ times. A higher pitting strength given was interpreted as being more durable.

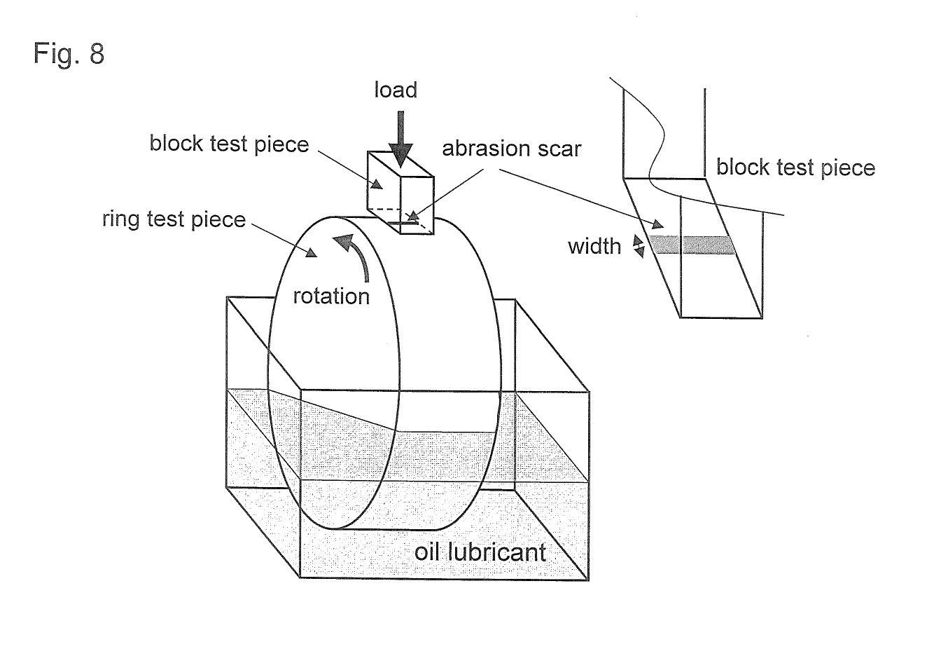

In the block on ring abrasion test, abrasion test was continued till the gross contact distance reached 8000 m, after the test, the width of abrasion scar incurred on the contact surface of the block test piece was measured, and it was determined that the narrower the width of abrasion scar, more hardly the abrasion proceeded, and the higher the abrasion strength was. FIG. 8 is a diagram schematically explaining a method of block on ring test conducted and the width of abrasion scar incurred on the contact face of a block test piece.

The microstructure was examined by observing a thin film sample prepared from a block sample with a TEM. That is to say, a thin piece of about 0.1 mm thickness including the carbonitrided surface layer was prepared, and this was electropolished to give a thin film sample, and the microstructure at a position of 70 μm depth from the surface was observed with a TEM to examine existence or nonexistence of dispersion of iron nitride particles of ε-Fe₃N and/or ζ-Fe₂N, and whether retained austenite is decomposed into bainitic ferrite, Fe₃C, and α″-Fe₁₆N₂ or not.

Hardness measurement was conducted using a Micro-Vickers hardness tester in such manner that the surface of 6 mm×10 mm where a block test piece was halved in center of 16 mm length was set as a surface to be tested. That is to say, it was buried in a resin so that the above-described surface became a surface to be tested, followed by mirror-like polishing. The above-described “surface contacting a ring test piece” shown in FIG. 5 was set to be a surface side, under a test force of 2.94 N (300 gf), hardness at positions of 30 μm, 50 μm and 100 μm depth was measured, subsequently, in proceeding by a pitch of 100 μm to the depth direction, hardness was obtained till a position of 1 mm depth, further subsequently, in proceeding by a pitch of 200 μm to the depth direction, hardness was obtained till a position of 2 mm depth, and a hardness profile in the vicinity of the surface including a hardened layer was obtained by connecting hardness at each position continuously. From this hardness profile, a position of “effective hardening depth” defined as a depth from the surface where Vickers hardness 550 was obtained. Hereinafter, the above-described hardness at a position of 30 μm depth from the surface was refereed to as “surface layer hardness.”

With regard to the respective steels 1 to 5, the above-described test results are collectively shown in Tables 7 to 11.

TABLE 7

| | | TEM observation result at a position | | | | | Roller pitting test | | Width of |
|---|---|---|---|---|---|---|---|---|---|
| | | of 70 μm depth from the surface | | | Surface | Effective | [accumulated rotation number] | | abrasion scar |
| | | Dispersion | Incompletely | | layer | hardening | Surface | Surface | on the block |
| | Test | of ε-Fe₃N and/or | hardened | | hardness | depth | pressure: | pressure: | test piece |
| Division | mark | ζ-Fe₂N | structure | Microstructure | (Hv) | (μm) | 2800 MPa | 3000 MPa | (μm) |
| Inventive | 1-a | observed | not observed | lath-like bainite | 740 | 750 | >2.0 × 10⁷ | 5.0 × 10⁶ | 750 |
| examples | 1-b | observed | not observed | lath-like bainite | 720 | 740 | >2.0 × 10⁷ | 1.2 × 10⁶ | 810 |
| | 1-c | observed | not observed | lath-like bainite | 725 | 730 | >2.0 × 10⁷ | 1.6 × 10⁶ | 800 |
| | 1-d | observed | not observed | lath-like bainite | 740 | 750 | >2.0 × 10⁷ | 4.3 × 10⁶ | 760 |
| | 1-e | observed | not observed | lath-like bainite | 730 | 730 | >2.0 × 10⁷ | 3.1 × 10⁶ | 780 |
| | 1-f | observed | not observed | lath-like bainite | 720 | 720 | >2.0 × 10⁷ | 1.1 × 10⁶ | 810 |
| | 1-g | observed | not observed | lath-like bainite | 715 | 720 | >2.0 × 10⁷ | 9.1 × 10⁵ | 850 |
| | 1-h | observed | not observed | lath-like bainite | 700 | 720 | >2.0 × 10⁷ | 8.0 × 10⁵ | 880 |
| | 1-i | observed | not observed | lath-like bainite | 705 | 730 | >2.0 × 10⁷ | 7.5 × 10⁵ | 910 |
| | 1-j | observed | not observed | lath-like bainite | 740 | 740 | >2.0 × 10⁷ | 5.2 × 10⁶ | 760 |
| Comparative | 1-p | * not observed | observed | * tempered martensite | 620 | 650 | 1.8 × 10⁶ | 2.0 × 10⁵ | 1630 |
| examples | 1-q | observed | not observed | * retained austenite | 520 | 600 | 1.5 × 10⁵ | 2.7 × 10⁴ | 2100 |
| | 1-r | observed | not observed | * ferrite, cementite, γ′ | 605 | 640 | 8.2 × 10⁵ | 9.8 × 10⁴ | 1860 |
| | 1-s | * not observed | observed | * tempered martensite | 630 | 650 | 2.0 × 10⁶ | 2.1 × 10⁵ | 1560 |
| | 1-t | * not observed | observed | * tempered martensite | 635 | 640 | 2.8 × 10⁶ | 2.3 × 10⁵ | 1520 |
| | 1-u | * not observed | observed | * tempered martensite | 700 | 720 | >2.0 × 10⁷ | 7.9 × 10⁵ | 1190 |
| | 1-v | * not observed | observed | * tempered martensite | 710 | 720 | >2.0 × 10⁷ | 8.6 × 10⁵ | 1150 |

The “lath-like bainite” in “Microstructure” column indicates that a mixed structure that the retained austenite is decomposed into bainitic ferrite. Fe₃C, and α″-Fe₁₆N₂. Additionally, the “γ′” means γ′-Fe₄N.
The “>2.0 × 10⁷” in “Roller pitting test” column indicates that no fatigue removal occurs even when the accumulated rotation number reached 2.0 × 10⁷ times.
The mark * indicates falling outside the conditions regulated by the present invention.

TABLE 8

| | | TEM observation result at a position | | | | | Roller pitting test | | Width of |
|---|---|---|---|---|---|---|---|---|---|
| | | of 70 μm depth from the surface | | | Surface | Effective | [accumulated rotation number] | | abrasion scar |
| | | Dispersion | Incompletely | | layer | hardening | Surface | Surface | on the block |
| | Test | of ε-Fe₃N and/or | hardened | | hardness | depth | pressure: | pressure: | test piece |
| Division | mark | ζ-Fe₂N | structure | Microstructure | (Hv) | (μm) | 2800 MPa | 3000 MPa | (μm) |
| Inventive | 2-a | observed | not observed | lath-like bainite | 740 | 760 | >2.0 × 10⁷ | 6.2 × 10⁶ | 730 |
| examples | 2-b | observed | not observed | lath-like bainite | 725 | 740 | >2.0 × 10⁷ | 1.5 × 10⁶ | 800 |
| | 2-c | observed | not observed | lath-like bainite | 720 | 740 | >2.0 × 10⁷ | 2.5 × 10⁵ | 810 |
| | 2-d | observed | not observed | lath-like bainite | 730 | 740 | >2.0 × 10⁷ | 5.0 × 10⁶ | 750 |
| | 2-e | observed | not observed | lath-like bainite | 725 | 720 | >2.0 × 10⁷ | 4.1 × 10⁶ | 780 |
| | 2-f | observed | not observed | lath-like bainite | 720 | 730 | >2.0 × 10⁷ | 2.5 × 10⁶ | 820 |
| | 2-g | observed | not observed | lath-like bainite | 720 | 720 | >2.0 × 10⁷ | 1.1 × 10⁶ | 850 |
| | 2-h | observed | not observed | lath-like bainite | 710 | 710 | >2.0 × 10⁷ | 9.6 × 10⁵ | 870 |
| | 2-i | observed | not observed | lath-like bainite | 715 | 730 | >2.0 × 10⁷ | 8.8 × 10⁵ | 900 |
| | 2-j | observed | not observed | lath-like bainite | 740 | 740 | >2.0 × 10⁷ | 6.7 × 10⁶ | 740 |
| Comparative | 2-p | * not observed | observed | * tempered martensite | 630 | 660 | 2.0 × 10⁶ | 4.0 × 10⁵ | 1520 |
| examples | 2-q | observed | not observed | * retained austenite | 515 | 590 | 1.6 × 10⁵ | 3.3 × 10⁴ | 2050 |
| | 2-r | observed | not observed | * ferrite, cementite, γ′, | 610 | 630 | 9.6 × 10⁵ | 1.0 × 10⁵ | 1800 |
| | 2-s | * not observed | observed | * tempered martensite | 630 | 650 | 3.2 × 10⁶ | 4.8 × 10⁵ | 1480 |
| | 2-t | * not observed | observed | * tempered martensite | 630 | 650 | 3.5 × 10⁶ | 5.1 × 10⁵ | 1470 |
| | 2-u | * not observed | observed | * tempered martensite | 705 | 730 | >2.0 × 10⁷ | 8.7 × 10⁵ | 1180 |
| | 2-v | * not observed | observed | * tempered martensite | 715 | 720 | >2.0 × 10⁷ | 9.5 × 10⁵ | 1170 |

The “lath-like bainite” in “Microstructure” column indicates that a mixed structure that the retained austenite is decomposed into bainitic ferrite, Fe₃C, and α″-Fe₁₆N₂. Additionally, the “γ′” means γ′-Fe₄N.
The “>2.0 × 10⁷” in “Roller pitting test” column indicates that no fatigue removal occurs even when the accumulated rotation number reached 2.0 × 10⁷ times.
The mark * indicates falling outside the conditions regulated by the present invention.

TABLE 9

| | | TEM observation result at a position | | | | | Roller pitting test | | Width of |
|---|---|---|---|---|---|---|---|---|---|
| | | of 70 μm depth from the surface | | | Surface | Effective | [accumulated rotation number] | | abrasion scar |
| | | Dispersion | Incompletely | | layer | hardening | Surface | Surface | on the block |
| | Test | of ε-Fe₃N and/or | hardened | | hardness | depth | pressure: | pressure: | test piece |
| Division | mark | ζ-Fe₂N | structure | Microstructure | (Hv) | (μm) | 2800 MPa | 3000 MPa | (μm) |
| Inventive | 3-a | observed | not observed | lath-like bainite | 745 | 760 | >2.0 × 10⁷ | 6.9 × 10⁶ | 720 |
| examples | 3-b | observed | not observed | lath-like bainite | 740 | 750 | >2.0 × 10⁷ | 5.0 × 10⁶ | 790 |
| | 3-c | observed | not observed | lath-like bainite | 725 | 730 | >2.0 × 10⁷ | 3.2 × 10⁶ | 810 |
| | 3-d | observed | not observed | lath-like bainite | 735 | 750 | >2.0 × 10⁷ | 6.0 × 10⁶ | 740 |
| | 3-e | observed | not observed | lath-like bainite | 730 | 730 | >2.0 × 10⁷ | 4.8 × 10⁶ | 790 |
| | 3-f | observed | not observed | lath-like bainite | 720 | 720 | >2.0 × 10⁷ | 3.0 × 10⁶ | 830 |
| | 3-g | observed | not observed | lath-like bainite | 725 | 740 | >2.0 × 10⁷ | 2.7 × 10⁶ | 840 |
| | 3-h | observed | not observed | lath-like bainite | 720 | 720 | >2.0 × 10⁷ | 2.6 × 10⁶ | 850 |
| | 3-i | observed | not observed | lath-like bainite | 715 | 730 | >2.0 × 10⁷ | 1.9 × 10⁶ | 890 |
| | 3-j | observed | not observed | lath-like bainite | 745 | 750 | >2.0 × 10⁷ | 7.2 × 10⁶ | 720 |
| Comparative | 3-p | * not observed | observed | * tempered martensite | 645 | 680 | 3.2 × 10⁶ | 4.6 × 10⁵ | 1560 |
| examples | 3-q | observed | not observed | * retained austenite | 520 | 600 | 2.8 × 10⁵ | 5.0 × 10⁴ | 2150 |
| | 3-r | observed | not observed | * ferrite, cementite, γ′ | 610 | 640 | 1.9 × 10⁶ | 3.8 × 10⁵ | 1780 |
| | 3-s | * not observed | observed | * tempered martensite | 640 | 660 | 4.1 × 10⁶ | 6.2 × 10⁵ | 1510 |
| | 3-t | * not observed | observed | * tempered martensite | 635 | 660 | 4.0 × 10⁶ | 6.4 × 10⁵ | 1490 |
| | 3-u | * not observed | observed | * tempered martensite | 710 | 730 | >2.0 × 10⁷ | 9.6 × 10⁵ | 1170 |
| | 3-v | * not observed | not observed | * tempered martensite | 720 | 740 | >2.0 × 10⁷ | 1.1 × 10⁶ | 1120 |

The “lath-like bainite” in “Microstructure” column indicates that a mixed structure that the retained austenite is decomposed into bainitic ferrite. Fe₃C, and α″-Fe₁₆N₂. Additionally, the “γ′” means γ′-Fe₄N.
The “>2.0 × 10⁷” in “Roller pitting test” column indicates that no fatigue removal occurs even when the accumulated rotation number reached 2.0 × 10⁷ times.
The mark * indicates falling outside the conditions regulated by the present invention.

TABLE 10

| | | TEM observation result at a position | | | | | Roller pitting-test | | Width of |
|---|---|---|---|---|---|---|---|---|---|
| | | of 70 μm depth from the surface | | | Surface | Effective | [accumulated rotation number] | | abrasion scar |
| | | Dispersion | Incompletely | | layer | hardening | Surface | Surface | on the block |
| | Test | of ε-Fe₃N and/or | hardened | | hardness | depth | pressure: | pressure: | test piece |
| Division | mark | ζ-Fe₃N | structure | Microstructure | (Hv) | (μm) | 2800 MPa | 3000 MPa | (μm) |
| Inventive | 4-a | observed | not observed | lath-like bainite | 750 | 770 | >2.0 × 10⁷ | 1.5 × 10⁷ | 690 |
| examples | 4-b | observed | not observed | lath-lite bainite | 735 | 740 | >2.0 × 10⁷ | 7.5 × 10⁶ | 780 |
| | 4-c | observed | not observed | lath-like bainite | 730 | 730 | >2.0 × 10⁷ | 6.6 × 10⁶ | 820 |
| | 4-d | observed | not observed | lath-like bainite | 745 | 750 | >2.0 × 10⁷ | 1.1 × 10⁷ | 740 |
| | 4-e | observed | not observed | lath-like baiaite | 740 | 740 | >2.0 × 10⁷ | 9.1 × 10⁶ | 770 |
| | 4-f | observed | not observed | lath-like bainite | 735 | 740 | >2.0 × 10⁷ | 6.8 × 10⁶ | 820 |
| | 4-g | observed | not observed | lath-like bainite | 730 | 720 | >2.0 × 10⁷ | 6.0 × 10⁶ | 830 |
| | 4-h | observed | not observed | lath-like bainite | 720 | 720 | >2.0 × 10⁷ | 5.2 × 10⁶ | 860 |
| | 4-i | observed | not observed | lath-like bainite | 720 | 730 | >2.0 × 10⁷ | 5.1 × 10⁶ | 880 |
| | 4-j | observed | not observed | lath-like bainite | 750 | 760 | >2.0 × 10⁷ | 1.8 × 10⁷ | 700 |
| Comparative | 4-p | * not observed | observed | * tempered martensite | 650 | 690 | 5.0 × 10⁶ | 1.5 × 10⁶ | 1500 |
| examples | 4-q | observed | not observed | * retained austenite | 515 | 580 | 2.6 × 10⁵ | 5.2 × 10⁴ | 1980 |
| | 4-r | observed | not observed | * ferrite, cementite γ′ | 610 | 630 | 1.4 × 10⁶ | 6.7 × 10⁵ | 1620 |
| | 4-s | * not observed | observed | * tempered martensite | 645 | 650 | 5.2 × 10⁶ | 8.8 × 10⁶ | 1570 |
| | 4-t | * not observed | observed | * tempered martensite | 640 | 650 | 4.8 × 10⁶ | 1.1 × 10⁶ | 1550 |
| | 4-u | * not observed | observed | * tempered martensite | 715 | 720 | >2.0 × 10⁷ | 4.0 × 10⁶ | 1120 |
| | 4-v | * not observed | observed | * tempered martensite | 725 | 730 | >2.0 × 10⁷ | 5.2 × 10⁶ | 1100 |

The “lath-like bainite” in “Microstructure” column indicates that a mixed structure that the retained austenite is decomposed into bainitic ferrite, Fe₃C, and α″-Fe₁₆N₂. Additionally, the “γ′” means γ′-Fe₄N.
The “>2.0 × 10⁷” in “Roller pitting test” column indicates that no fatigue removal occurs even when the accumulated rotation number reached 2.0 × 10⁷ times.
The mark * indicates falling outside the conditions regulated by the present invention.

TABLE 11

| | | TEM observation result at a position | | | | | Roller pitting test | | Width of |
|---|---|---|---|---|---|---|---|---|---|
| | | of 70 μm depth from the surface | | | Surface | Effective | [accumulated rotation number] | | abrasion scar |
| | | Dispersion | Incompletely | | layer | hardening | Surface | Surfece | on the block |
| | Test | of ε-Fe₃N and/or | hardened | | hardness | depth | pressure: | pressure: | test piece |
| Division | mark | ζ-Fe₂N | structure | Microstructure | (Hv) | (μm) | 2800 MPa | 3000 MPa | (μm) |
| Inventive | 5-a | observed | not observed | lath-like bainite | 770 | 800 | >2.0 × 10⁷ | >2.0 × 10⁷ | 680 |
| examples | 5-b | observed | not observed | lath-like bainite | 750 | 770 | >2.0 × 10⁷ | >2.0 × 10⁷ | 740 |
| | 5-c | observed | not observed | lath-like bainite | 745 | 750 | >2.0 × 10⁷ | 1.2 × 10⁷ | 800 |
| | 5-d | observed | not observed | lath-like bainite | 755 | 760 | >2.0 × 10⁷ | >2.0 × 10⁷ | 730 |
| | 5-e | observed | not observed | lath-like bainite | 750 | 750 | >2.0 × 10⁷ | >2.0 × 10⁷ | 750 |
| | 5-f | observed | not observed | lath-like bainite | 745 | 760 | >2.0 × 10⁷ | 9.8 × 10⁶ | 810 |
| | 5-g | observed | not observed | lath-like bainite | 740 | 750 | >2.0 × 10⁷ | 8.8 × 10⁶ | 800 |
| | 5-h | observed | not observed | lath-like bainite | 730 | 740 | >2.0 × 10⁷ | 7.7 × 10⁶ | 850 |
| | 5-i | observed | not observed | lath-like bainite | 730 | 740 | >2.0 × 10⁷ | 6.5 × 10⁶ | 870 |
| | 5-j | observed | not observed | lath-like bainite | 765 | 790 | >2.0 × 10⁷ | >2.0 × 10⁷ | 690 |
| Comparative | 5-p | * not observed | not observed | * tempered martensite | 690 | 700 | 5.0 × 10⁶ | 4.2 × 10⁶ | 1350 |
| examples | 5-q | observed | not observed | * retained austenite | 535 | 610 | 2.6 × 10⁵ | 5.0 × 10⁴ | 2020 |
| | 5-r | observed | not observed | * ferrite, cementite, γ′ | 625 | 640 | 1.4 × 10⁶ | 5.9 × 10⁵ | 1580 |
| | 5-s | * not observed | not observed | * tempered martensite | 660 | 670 | 5.2 × 10⁶ | 2.5 × 10⁶ | 1420 |
| | 5-t | * not observed | not observed | * tempered martensite | 650 | 670 | 4.8 × 10⁶ | 2.6 × 10⁶ | 1440 |
| | 5-u | * not observed | not observed | * tempered martensite | 730 | 740 | >2.0 × 10⁷ | 6.2 × 10⁶ | 1070 |
| | 5-v | * not observed | not observed | * tempered martensite | 740 | 750 | >2.0 × 10⁷ | 8.5 × 10⁶ | 1050 |

The “lath-like bainite” in “Microstructure” column indicates that a mixed structure that the retained austenite is decomposed into bainitic ferrite. Fe₃C, and α″-Fe₁₆N₂. Additionally, the “γ′” means γ′-Fe₄N.
The “>2.0 × 10⁷” in “Roller pitting test” column indicates that no fatigue removal occurs even when the accumulated rotation number reached 2.0 · 10⁷ times.
The mark * indicates falling outside the conditions regulated by the present invention.

Table 7 is the test result for the steel 1, a steel corresponding to the SCr420 specified in JIS, was used. In Table 7, test marks 1-a to 1-j are examples of the present invention.

As shown in Table 3, in the case of each test mark of the above-described examples of the present invention, since “nitrogen potential” in the carbonitriding process is as high as 0.20 to 0.60% and the heat treatment condition of the present invention is satisfied, dispersion of iron nitride particles of ε-Fe₃N and/or ζ-Fe₂N was observed in the microstructure at a position of 70 μm depth from the surface. In addition, since the tempering temperature after quenching is 260 to 340° C. and the heat treatment condition of the present invention is satisfied, the microstructures in the case of these test marks were all “lath-like bainite,” that is, a mixed structure where retained austenite was decomposed into bainitic ferrite, Fe₃C, and α″-Fe₁₆N₂ as shown in FIG. 3B.

Additionally, since the effective hardening depth of the above-described test marks is 720 to 750 μm, the foregoing “position of 70 μm depth from the surface” is well within a region that matches the “region to a position of effective hardening depth from the surface of a hardened layer” specified by the present invention.

Since all the above-described test marks 1-a to 1-j have the microstructure specified by the present invention, the surface layer hardness is as high as 700 to 740 in Vickers hardness scale, and in the roller pitting test at a surface pressure of 2800 MPa, no fatigue removal occurred even when the accumulated rotation cycle reached 2.0×10⁷ cycles, so it is clear for them to have a large pitting strength. Further, in the case of the above-described test marks, the width of abrasion groove as an index of abrasion strength is 750 to 910 μm, which is less than 1000 μm, so it is clear for them to be excellent in abrasion strength.

In contrast to the above-mentioned test marks, in the case of comparative examples of test marks 1-p to 1-v, both abrasion strength and pitting strength are inferior (test marks 1-p to 1-t, or abrasion strength is inferior (test marks 1-u and 1-v).

As shown in Table 3, in the case of test marks 1-p, 1-s, and 1-t, “nitrogen potential” in the carbonitriding process is as low as 0.10 to 0.14%, and the heat treatment condition of the present invention is not satisfied. Hence, in the case of the above-described test marks, in the microstructure at a position of 70 μm depth from the surface, not only no dispersion of iron nitride particles of ε-Fe₃N or ζ-Fe₂N was observed but also incompletely hardened structure was formed. Further, in the case of these test marks, a “lath-like bainite structure” similar to the foregoing examples of the present invention was not formed even by tempering.

Since the effective hardening depth of the above-described test marks is 640 to 650 μm, the foregoing “position of 70 μm depth from the surface” is well within a region that matches the “region to a position of effective hardening depth from the surface of a hardened layer” specified by the present invention.

As described above, in the case of test marks 1-p, 1-s, and 1-t, since each does not have the microstructure specified by the present invention, the surface layer hardness is as low as 620 to 635 in Vickers hardness scale, in the roller pitting test at a surface pressure of 2800 MPa, fatigue removal occurred at the accumulated rotation cycle of 1.8 to 2.8×10⁶ cycles, and pitting strength is low. Further, in the case of the above-described test marks, the width of abrasion groove is 1520 to 1630 μm, largely exceeding 1000 μm, so it is understood that abrasion strength is inferior.

As shown in Table 3, in the case of test mark 1-u, “nitrogen potential” in the carbonitriding process is as low as 0.04%, further, the tempering temperature is 180° C., and the heat treatment condition of the present invention is not satisfied. In the case of test mark 1-v, it is treated practically in the same condition as gas-carburizing without flowing ammonia gas in a furnace in the carbonitriding process, and also the tempering temperature is 180° C., and the heat treatment condition of the present invention is not satisfied. Hence, in the case of test marks 1-u and 1-v, in the microstructure at a position of 70 μm depth from the surface, no dispersion of iron nitride particles of ε-Fe₃N or ζ-Fe₂N was observed. In addition, in the case of these test marks, a “lath-like bainite structure” similar to the foregoing examples of the present invention was not formed even by tempering, but it was found to be “tempered martensite.”

Since the effective hardening depth of the above-described test marks is 720 μm, the foregoing “position of 70 μm depth from the surface” is well within a region that matches the “region to a position of effective hardening depth from the surface of a hardened layer” specified by the present invention.

In the case of test marks 1-u and 1-v, the surface layer hardness is as high as 700 and 710 in Vickers hardness scale, respectively, and is almost the same as the case of test marks 1-a to 1-j of the foregoing examples of the present invention, thus, in the roller pitting test at a surface pressure of 2800 MPa, no fatigue removal occurred even when the accumulated rotation cycle reached 2.0×10⁷ cycles, and they have a large pitting strength. However, in the case of test marks 1-u and 1-v, since they do not have the microstructure specified by the present invention as describe above, the widths of abrasion groove were 1150 μm and 1190 μm, respectively, exceeding 1000 μm, and they were inferior in abrasion strength.

As shown in Table 3, in the case of test marks 1-q and 1-r, since “nitrogen potential” in the carbonitriding process is both as high as 0.55% and the condition specified by the present invention is satisfied, dispersion of iron nitride particles of ε-Fe₃N and/or ζ-Fe₂N was observed in the microstructure at a position of 70 μm depth from the surface.

However, in the case of test mark 1-q, since the tempering temperature is 180° C. and the heat treatment condition of the present invention is not satisfied, retained austenite did not sufficiently undergo bainite transformation, and a “lath-like bainite structure” similar to the case of the foregoing examples of the present invention was not obtained. In the case of test mark 1-r, since the tempering temperature is as high as 400° C. and the heat treatment condition of the present invention is not satisfied, retained austenite was decomposed into ferrite, cementite, and rod-like coarse γ′-Fe₄N nitride, and a “lath-like bainite structure” similar to the case of the foregoing examples of the present invention was not obtained.

Since the effective hardening depth of the above-described test marks is 600 to 640 μm, the foregoing “position of 70 μm depth from the surface” is well within a region that matches the “region to a position of effective hardening depth from the surface of a hardened layer” specified by the present invention.

As described above, in the case of test marks 1-q and 1-r, since both do not have the microstructure specified by the present invention, the surface layer hardness is as low as 520 and 605 in Vickers hardness scale, respectively, in the roller pitting test at a surface pressure of 2800 MPa, fatigue removal occurred at the accumulated rotation cycle of 1.5 to 8.2×10⁵ cycles, and pitting strength is low. Further, in the case of the above-described test marks, the widths of abrasion groove are 2100 μm and 1860 μm, respectively, largely exceeding 1000 μm; and thus each abrasion strength thereof was also inferior.

Table 8 is the test result for the steel 2, a steel corresponding to a Si-enriched steel of the SCr420 specified in JIS, was used. In Table 8, test marks 2-a to 2-j are examples of the present invention.

As shown in Table 3, in the case of each test mark of the above-described examples of the present invention, since “nitrogen potential” in the carbonitriding process is as high as 0.20 to 0.59% and the heat treatment condition of the present invention is satisfied, dispersion of iron nitride particles of ε-Fe₃N and/or ζ-Fe₂N was observed in the microstructure at a position of 70 μm depth from the surface. Since the tempering temperature after quenching is 260 to 340° C. and the heat treatment condition of the present invention is satisfied, the microstructures in the case of these test marks were all “lath-like bainite,” that is, a mixed structure where retained austenite was decomposed into bainitic ferrite, Fe₃C, and α″-Fe₁₆N₂ as shown in FIG. 3B.

Since the effective hardening depth of the above-described test marks is 710 to 760 μm, the foregoing “position of 70 μm depth from the surface” is well within a region that matches the “region to a position of effective hardening depth from the surface of a hardened layer” specified by the present invention.

Since all the above-described test marks 2-a to 2-j have the microstructure specified by the present invention, the surface layer hardness is as high as 710 to 740 in Vickers hardness scale, and in the roller pitting test at a surface pressure of 2800 MPa, no fatigue removal occurred even when the accumulated rotation cycle reached 2.0×10⁷ cycles, so it is clear for them to have a large pitting strength. Further, in the case of the above-described test marks, the width of abrasion groove as an index of abrasion strength is 730 to 900 μm, which is less than 1000 μm, so it is clear for them to be excellent in abrasion strength.

In contrast to the above-mentioned test marks, in the case of comparative examples of test marks 2-p to 2-v, both abrasion strength and pitting strength are inferior (test marks 2-p to 2-t), or abrasion strength is inferior (test marks 2-u and 2-v).

That is to say, as shown in Table 3, in the case of test marks 2-p, 2-s, and 2-t, “nitrogen potential” in the carbonitriding process is as low as 0.11 to 0.13%, and the heat treatment condition of the present invention is not satisfied. Hence, in the case of the above-described test marks, in the microstructure at a position of 70 μm depth from the surface, not only no dispersion of iron nitride particles of ε-Fe₃N or ζ-Fe₂N was observed but also incompletely hardened structure was formed. Further, in the case of these test marks, a “lath-like bainite structure” similar to the foregoing examples of the present invention was not formed even by tempering.

Since the effective hardening depth of the above-described test marks is 650 to 660 μm, the foregoing “position of 70 μm depth from the surface” is well within a region that matches the “region to a position of effective hardening depth from the surface of a hardened layer” specified by the present invention.

As described above, in the case of test marks 2-p, 2-s, and 2-t, since each does not have the microstructure specified by the present invention, the surface layer hardness is as low as 630 in Vickers hardness scale, in the roller pitting test at a surface pressure of 2800 MPa, fatigue removal occurred at the accumulated rotation cycle of 2.0 to 3.5×10⁶ cycles, and pitting strength is low. Further, in the case of the above-described test marks, the width of abrasion groove is 1470 to 1520 μm, largely exceeding 1000 μm, so it is understood that abrasion strength is inferior.

As shown in Table 3, in the case of test mark 2-u, “nitrogen potential” in the carbonitriding process is as low as 0.04%, further, the tempering temperature is 180° C., and the heat treatment condition of the present invention is not satisfied. In the case of test mark 2-v, it is treated practically in the same condition as gas-carburizing without flowing ammonia gas in a furnace in the carbonitriding process, and also the tempering temperature is 180° C., and the heat treatment condition of the present invention is not satisfied. Hence, in the case of test marks 2-u and 2-v, in the microstructure at a position of 70 μm depth from the surface, no dispersion of iron nitride particles of ε-Fe₃N or ζ-Fe₂N was observed. In the case of these test marks, a “lath-like bainite structure” similar to the foregoing examples of the present invention was not formed even by tempering, but it was found to be “tempered martensite.”

Since the effective hardening depth of the above-described test marks is 720 to 730 μm, the foregoing “position of 70 μm depth from the surface” is well within a region that matches the “region to a position of effective hardening depth from the surface of a hardened layer” specified by the present invention.

In the case of test marks 2-u and 2-v, the surface layer hardness is as high as 705 and 715 in Vickers hardness scale, respectively, and is almost the same as the case of test marks 2-a to 2-j of the foregoing examples of the present invention, thus, in the roller pitting test at a surface pressure of 2800 MPa, no fatigue removal occurred even when the accumulated rotation cycle reached 2.0×10⁷ cycles, having a large pitting strength. However, in the case of test marks 2-u and 2-v, since they do not have the microstructure specified by the present invention as describe above, the widths of abrasion groove were 1180 μm and 1170 μm, respectively, exceeding 1000 μm, and they were inferior in abrasion strength.

As shown in Table 3, in the case of test marks 2-q and 2-r, since “nitrogen potential” in the carbonitriding process is both as high as 0.54% and the condition specified by the present invention is satisfied, dispersion of iron nitride particles of ε-Fe₃N and/or ζ-Fe₂N was observed in the microstructure at a position of 70 μm depth from the surface.

However, in the case of test mark 2-q, since the tempering temperature is 180° C. and the heat treatment condition of the present invention is not satisfied, retained austenite did not sufficiently undergo bainite transformation, and a “lath-like bainite structure” similar to the case of the foregoing examples of the present invention was not obtained. In the case of test mark 2-r, since the tempering temperature is as high as 400° C. and the heat treatment condition of the present invention is not satisfied, retained austenite was decomposed into ferrite, cementite, and rod-like coarse γ′-Fe₄N nitride, and a “lath-like bainite structure” similar to the case of the foregoing examples of the present invention was not obtained.

Additionally, since the effective hardening depth of the above-described test marks is 590 to 630 μm, the foregoing “position of 70 μm depth from the surface” is well within a region that matches the “region to a position of effective hardening depth from the surface of a hardened layer” specified by the present invention.

As described above, in the case of test marks 2-q and 2-r, since both do not have the microstructure specified by the present invention, the surface layer hardness is as low as 515 and 610 in Vickers hardness scale, respectively, and in the roller pitting test at a surface pressure of 2800 MPa, fatigue removal occurred at the accumulated rotation cycle reached 1.6 to 9.6×10⁵ cycles, and pitting strength is low. Further, in the above-described test marks, the widths of abrasion groove are 2050 μm and 1800 μm, respectively, largely exceeding 1000 μm; and thus each abrasion strength thereof was also inferior.

Table 9 is the test result for the steel 3, a steel corresponding to a Cr-enriched steel of the SCr420 specified in JIS, was used. In Table 9, test marks 3-a to 3-j are examples of the present invention.

As shown in Table 3, in the case of each test mark of the above-described examples of the present invention, since “nitrogen potential” in the carbonitriding process is as high as 0.21 to 0.58% and the heat treatment condition of the present invention is satisfied, dispersion of iron nitride particles of ε-Fe₃N and/or ζ-Fe₂N was observed in the microstructure at a position of 70 μm depth from the surface. Since the tempering temperature after quenching is 260 to 340° C. and the heat treatment condition of the present invention is satisfied, the microstructures in the case of these test marks were all “lath-like bainite,” that is, a mixed structure where retained austenite was decomposed into bainitic ferrite, Fe₃C, and α″-Fe₁₆N₂ as shown in FIG. 3B.

Since the effective hardening depth of the above-described test marks is 720 to 760 μm, the foregoing “position of 70 μm depth from the surface” is well within a region that matches the “region to a position of effective hardening depth from the surface of a hardened layer” specified by the present invention.

Since all the above-described test marks 3-a to 3-j have the microstructure specified by the present invention, the surface layer hardness is as high as 715 to 745 in Vickers hardness scale, and in the roller pitting test at a surface pressure of 2800 MPa, no fatigue removal occurred even when the accumulated rotation cycle reached 2.0×10⁷ cycles, so it is clear for them to have a large pitting strength. Further, in the case of the above-described test marks, the width of abrasion groove as an index of abrasion strength is 720 to 890 μm, which is less than 1000 μm, so it is clear for them to be excellent in abrasion strength.

In contrast to the above-mentioned test marks, in the case of comparative examples of test marks 3-p to 3-v, both abrasion strength and pitting strength are inferior (test marks 3-p to 3-t), or abrasion strength is inferior (test marks 3-u and 3-v).

That is to say, as shown in Table 3, in the case of test marks 3-p, 3-s, and 3-t, “nitrogen potential” in the carbonitriding process is as low as 0.11 to 0.15%, and the heat treatment condition of the present invention is not satisfied. Hence, in the case of the above-described test marks, in the microstructure at a position of 70 μm depth from the surface, not only no dispersion of iron nitride particles of ε-Fe₃N or ζ-Fe₂N was observed but also incompletely hardened structure was formed. Further, in the case of these test marks, a “lath-like bainite structure” similar to the foregoing examples of the present invention was not formed even by tempering.

Since the effective hardening depth of the above-described test marks is 660 to 680 μm, the foregoing “position of 70 μm depth from the surface” is well within a region that matches the “region to a position of effective hardening depth from the surface of a hardened layer” specified by the present invention.

As described above, in the case of test marks 3-p, 3-s, and 3-t, since each does not have the microstructure specified by the present invention, the surface layer hardness is as low as 635 to 645 in Vickers hardness scale, in the roller pitting test at a surface pressure of 2800 MPa, fatigue removal occurred at the accumulated rotation cycle of 3.2 to 4.1×10⁶ cycles, and pitting strength is low. Further, in the case of the above-described test marks, the width of abrasion groove is 1490 to 1560 μm, largely exceeding 1000 μm, so it is understood that abrasion strength is inferior.

As shown in Table 3, in the case of test mark 3-u, “nitrogen potential” in the carbonitriding process is as low as 0.04%, further, the tempering temperature is 180° C., and the heat treatment condition of the present invention is not satisfied. In the case of test mark 3-v, it is treated practically in the same condition as gas-carburizing without flowing ammonia gas in a furnace in the carbonitriding process, and also the tempering temperature is 180° C., and the heat treatment condition of the present invention is not satisfied. Hence, in the case of test marks 3-u and 3-v, in the microstructure at a position of 70 μm depth from the surface, no dispersion of iron nitride particles of ε-Fe₃N or ζ-Fe₂N was observed. In the case of these test marks, a “lath-like bainite structure” similar to the foregoing examples of the present invention was not formed even by tempering, but it was found to be “tempered martensite.”

Since the effective hardening depth of the above-described test marks is 730 to 740 μm, the foregoing “position of 70 μm depth from the surface” is well within a region that matches the “region to a position of effective hardening depth from the surface of a hardened layer” specified by the present invention.

In the case of test marks 3-u and 3-v, the surface layer hardness is as high as 710 and 720 in Vickers hardness scale, respectively, and is almost the same as the case of test marks 3-a to 3-j of the foregoing examples of the present invention, thus, in the roller pitting test at a surface pressure of 2800 MPa, no fatigue removal occurred even when the accumulated rotation cycle reached 2.0×10⁷ cycles, having a large pitting strength. However, in the case of test marks 3-u and 3-v, since they do not have the microstructure specified by the present invention as describe above, the widths of abrasion groove were 1170 μm and 1120 μm, respectively, exceeding 1000 μm, and they were inferior in abrasion strength.

As shown in Table 3, in the case of test marks 3-q and 3-r, since “nitrogen potential” in the carbonitriding process is both as high as 0.56% and the condition specified by the present invention is satisfied, dispersion of iron nitride particles of ε-Fe₃N and/or ζ-Fe₂N was observed in the microstructure at a position of 70 μm depth from the surface.

However, in the case of test mark 3-q, since the tempering temperature is 180° C. and the heat treatment condition of the present invention is not satisfied, retained austenite did not sufficiently undergo bainite transformation, and a “lath-like bainite structure” similar to the case of the foregoing examples of the present invention was not obtained. In the case of test mark 3-r, since the tempering temperature is as high as 400° C. and the heat treatment condition of the present invention is not satisfied, retained austenite was decomposed into ferrite, cementite, and rod-like coarse γ′-Fe₄N nitride, and a “lath-like bainite structure” similar to the case of the foregoing examples of the present invention was not obtained.

Additionally, since the effective hardening depth of the above-described test marks is 600 to 640 μm, the foregoing “position of 70 μm depth from the surface” is well within a region that matches the “region to a position of effective hardening depth from the surface of a hardened layer” specified by the present invention.

As described above, in the case of test marks 3-q and 3-r, since both do not have the microstructure specified by the present invention, the surface layer hardness is as low as 520 and 610 in Vickers hardness scale, respectively, in the roller pitting test at a surface pressure of 2800 MPa, fatigue removal occurred at the accumulated rotation cycle of 2.8×10⁵ cycles and 1.9×10⁶ cycles, respectively, and pitting strength is low. Further, in the case of the above-described test marks, the widths of abrasion groove are 2150 μm and 1780 μm, respectively, largely exceeding 1000 μm; and thus each abrasion strength thereof was also inferior.

Table 10 is the test result for the steel 4, a steel corresponding to a Si and Cr-enriched steel of the SCr420 specified in JIS, was used. In Table 10, test marks 4-a to 4-j are examples of the present invention.

In the case of each test mark of the above-described examples of the present invention, as shown in Table 4, since “nitrogen potential” in the carbonitriding process is as high as 0.20 to 0.57% and the heat treatment condition of the present invention is satisfied, dispersion of iron nitride particles of ε-Fe₃N and/or ζ-Fe₂N was observed in the microstructure at a position of 70 μm depth from the surface. Since the tempering temperature after quenching is 260 to 340° C. and the heat treatment condition of the present invention is satisfied, the microstructures in the case of these test marks were all “lath-like bainite,” that is, a mixed structure where retained austenite was decomposed into bainitic ferrite, Fe₃C, and α″-Fe₁₆N₂ as shown in FIG. 3B.

Since the effective hardening depth of the above-described test marks is 720 to 770 μm, the foregoing “position of 70 μm depth from the surface” is well within a region that matches the “region to a position of effective hardening depth from the surface of a hardened layer” specified by the present invention.

Since all the above-described test marks 4-a to 4-j have the microstructure specified by the present invention, the surface layer hardness is as high as 720 to 750 in Vickers hardness scale, and in the roller pitting test at a surface pressure of 2800 MPa, no fatigue removal occurred even when the accumulated rotation cycle reached 2.0×10⁷ cycles, so it is clear for them to have a large pitting strength. Further, in the case of the above-described test marks, the width of abrasion groove as an index of abrasion strength is 690 to 880 μm, which is less than 1000 μm, so it is clear for them to be excellent in abrasion strength.

Of the above-described test marks, in the case of test marks 4-a and 4-j, since the surface layer hardness of 750 in Vickers hardness scale was obtained, although the accumulated rotation cycle in the roller pitting test at a surface pressure of 3000 MPa did not reach 2.0×10⁷ cycles, they were as high as 1.5×10⁷ cycles and 1.8×10⁷ cycles, respectively, having the same pitting strength as the case where steel 5, a steel corresponding to the following SCM420 specified in JIS, was used.

In contrast to the above-mentioned test marks, in the case of comparative examples of test marks 4-p to 4-v, both abrasion strength and pitting strength are inferior (test marks 4-p to 4-t), or abrasion strength is inferior (test marks 4-u and 4-v).

That is to say, as shown in Table 4, in the case of test marks 4-p, 4-s, and 4-t, “nitrogen potential” in the carbonitriding process is as low as 0.11 to 0.13%, and the heat treatment condition of the present invention is not satisfied. Hence, in the case of the above-described test marks, in the microstructure at a position of 70 μm depth from the surface, not only no dispersion of iron nitride particles of ε-Fe₃N or ζ-Fe₂N was observed but also incompletely hardened structure was formed. Further, in the case of these test marks, a “lath-like bainite structure” similar to the foregoing examples of the present invention was not formed even by tempering.

Since the effective hardening depth of the above-described test marks is 650 to 690 μm, the foregoing “position of 70 μm depth from the surface” is well within a region that matches the “region to a position of effective hardening depth from the surface of a hardened layer” specified by the present invention.

As described above, in the case of test marks 4-p, 4-s, and 4-t, since each does not have the microstructure specified by the present invention, the surface layer hardness is as low as 640 to 650 in Vickers hardness scale, in the roller pitting test at a surface pressure of 2800 MPa, fatigue removal occurred at the accumulated rotation cycle of 4.8 to 5.2×10⁶ cycles, and pitting strength is low. Further, in the case of the above-described test marks, the width of abrasion groove is 1500 to 1570 μm, largely exceeding 1000 μm, so it is understood that abrasion strength is inferior.

As shown in Table 4, in the case of test mark 4-u, “nitrogen potential” in the carbonitriding process is as low as 0.04%, further, the tempering temperature is 180° C., and the heat treatment condition of the present invention is not satisfied. In the case of test mark 4-v, it is treated practically in the same condition as gas-carburizing without flowing ammonia gas in a furnace in the carbonitriding process, and also the tempering temperature is 180° C., and the heat treatment condition of the present invention is not satisfied. Hence, in the case of test marks 4-u and 4-v, in the microstructure at a position of 70 μm depth from the surface, no dispersion of iron nitride particles of ε-Fe₃N or ζ-Fe₂N was observed. In the case of these test marks, a “lath-like bainite structure” similar to the foregoing examples of the present invention was not formed even by tempering, but it was found to be “tempered martensite.”

Since the effective hardening depth of the above-described test marks is 720 to 730 μm, the foregoing “position of 70 μm depth from the surface” is well within a region that matches the “region to a position of effective hardening depth from the surface of a hardened layer” specified by the present invention.

In the case of test marks 4-u and 4-v, the surface layer hardness is as high as 715 and 725 in Vickers hardness scale, respectively, and is almost the same as the case of test marks 4-a to 4-j of the foregoing examples of the present invention, thus, in the roller pitting test at a surface pressure of 2800 MPa, no fatigue removal occurred even when the accumulated rotation cycle reached 2.0×10⁷ cycles, having a large pitting strength. However, in the case of test marks 4-u and 4-v, since they do not have the microstructure specified by the present invention as describe above, the widths of abrasion groove were 1120 μm and 1100 μm, respectively, exceeding 1000 μm, and they were inferior in abrasion strength.

As shown in Table 4, in the case of test marks 4-q and 4-r, since “nitrogen potential” in the carbonitriding process is both as high as 0.57% and the condition specified by the present invention is satisfied, dispersion of iron nitride particles of ε-Fe₃N and/or ζ-Fe₂N was observed in the microstructure at a position of 70 μm depth from the surface.

However, in the case of test mark 4-q, since the tempering temperature is 180° C. and the heat treatment condition of the present invention is not satisfied, retained austenite did not sufficiently undergo bainite transformation, and a “lath-like bainite structure” similar to the case of the foregoing examples of the present invention was not obtained. In the case of test mark 4-r, since the tempering temperature is as high as 400° C. and the heat treatment condition of the present invention is not satisfied, retained austenite was decomposed into ferrite, cementite, and rod-like coarse γ′-Fe₄N nitride, and a “lath-like bainite structure” similar to the case of the foregoing examples of the present invention was not obtained.

Since the effective hardening depth of the above-described test marks is 580 to 630 μm, the foregoing “position of 70 μm depth from the surface” is well within a region that matches the “region to a position of effective hardening depth from the surface of a hardened layer” specified by the present invention.

As described above, in the test marks 4-q and 4-r, since both do not have the microstructure specified by the present invention, the surface layer hardness is as low as 515 and 610 in Vickers hardness scale, respectively, and in the roller pitting test at a surface pressure of 2800 MPa, fatigue removal occurred at the accumulated rotation cycle of 2.6×10⁵ cycles and 1.4×10⁶ cycles, respectively, and pitting strength is low. Further, in the above-described test marks, the widths of abrasion groove are 1980 μm and 1620 μm, respectively, largely exceeding 1000 μm; and thus each abrasion strength thereof was also inferior.

Table 11 is the test result for the steel 5, a steel corresponding to the SCM420 specified in JIS, was used. In Table 11, test marks 5-a to 5-j are examples of the present invention.

As shown in Table 4, in the case of each test mark of the above-described examples of the present invention, since “nitrogen potential” in the carbonitriding process is as high as 0.22 to 0.57% and the heat treatment condition of the present invention is satisfied, dispersion of iron nitride particles of ε-Fe₃N and/or ζ-Fe₂N was observed in the microstructure at a position of 70 μm depth from the surface. Since the tempering temperature after quenching is 260 to 340° C. and the heat treatment condition of the present invention is satisfied, the microstructures in the case of these test marks were all “lath-like bainite,” that is, a mixed structure where retained austenite was decomposed into bainitic ferrite, Fe₃C, and α″-Fe₁₆N₂ as shown in FIG. 3B.

Since the effective hardening depth of the above-described test marks is 740 to 800 μm, the foregoing “position of 70 μm depth from the surface” is well within a region that matches the “region to a position of effective hardening depth from the surface of a hardened layer” specified by the present invention.

Since all the above-described test marks 5-a to 5-j have the microstructure specified by the present invention, the surface layer hardness is as high as 730 to 770 in Vickers hardness scale, and in the roller pitting test at a surface pressure of 2800 MPa, no fatigue removal occurred even when the accumulated rotation cycle reached 2.0×10⁷ cycles. In the case of half of the test marks, even in the roller pitting test at a surface pressure of 3000 MPa, no fatigue removal occurred at the accumulated rotation cycle of 2.0×10⁷ cycles, so it is clear for them to have a very large pitting strength. Further, in the case of the above-described test marks 5-a to 5-j, the width of abrasion groove as an index of abrasion strength is 680 to 870 μm, which is less than 1000 μm, so it is clear for them to be excellent in abrasion strength.

In contrast to the above-mentioned test marks, in the case of comparative examples of test marks 5-p to 5-v, both abrasion strength and pitting strength are inferior (test marks 5-p to 5-t), or abrasion strength is inferior (test marks 5-u and 5-v).

That is to say, as shown in Table 4, in the case of test marks 5-p, 5-s, and 5-t, “nitrogen potential” in the carbonitriding process is as low as 0.09 to 0.12%, and the heat treatment condition of the present invention is not satisfied. Hence, in the case of the above-described test marks, in the microstructure at a position of 70 μm depth from the surface, no dispersion of iron nitride particles of ε-Fe₃N or ζ-Fe₂N was observed. Although there was no formation of incompletely hardened structure, in the case of these test marks, a “lath-like bainite structure” similar to the foregoing examples of the present invention was not formed even by tempering.

Since the effective hardening depth of the above-described test marks is 670 to 700 μm, the foregoing “position of 70 μm depth from the surface” is well within a region that matches the “region to a position of effective hardening depth from the surface of a hardened layer” specified by the present invention.

As described above, in the case of test marks 5-p, 5-s, and 5-t, since each does not have the microstructure specified by the present invention, the surface layer hardness is as low as 650 to 690 in Vickers hardness scale, in the roller pitting test at a surface pressure of 2800 MPa, fatigue removal occurred at the accumulated rotation cycle of 4.8 to 5.2×10⁶ cycles, and pitting strength is low. Further, in the case of the above-described test marks, the width of abrasion groove is 1350 to 1440 μm, largely exceeding 1000 μm, so it is also clear to be inferior in abrasion strength.

As shown in Table 4, in the case of test mark 5-u, “nitrogen potential” in the carbonitriding process is as low as 0.04%, further, the tempering temperature is 180° C., and the heat treatment condition of the present invention is not satisfied. In the case of test mark 5-v, it is treated practically in the same condition as gas-carburizing without flowing ammonia gas in a furnace in the carbonitriding process, and also the tempering temperature is 180° C., and the heat treatment condition of the present invention is not satisfied. Hence, in the case of test marks 5-u and 5-v, in the microstructure at a position of 70 μm depth from the surface, no dispersion of iron nitride particles of ε-Fe₃N or ζ-Fe₂N was observed. In the case of these test marks, a “lath-like bainite structure” similar to the foregoing examples of the present invention was not formed even by tempering, but it was found to be “tempered martensite.”

Since the effective hardening depth of the above-described test marks is 740 to 750 μm, the foregoing “position of 70 μm depth from the surface” is well within a region that matches the “region to a position of effective hardening depth from the surface of a hardened layer” specified by the present invention.

In the case of test marks 5-u and 5-v, the surface layer hardness is as high as 730 and 740 in Vickers hardness scale, respectively, and is almost the same as the case of test marks 5-a to 5-j of the foregoing examples of the present invention, thus, in the roller pitting test at a surface pressure of 2800 MPa, no fatigue removal occurred even when the accumulated rotation cycle reached 2.0×10⁷ cycles, having a large pitting strength. However, in the case of test marks 5-u and 5-v, since they do not have the microstructure specified by the present invention as describe above, the widths of abrasion groove were 1070 μm and 1050 μm, respectively, exceeding 1000 μm, and they were inferior in abrasion strength.

As shown in Table 4, in the case of test marks 5-q and 5-r, since “nitrogen potential” in the carbonitriding process is both as high as 0.56% and the condition specified by the present invention is satisfied, dispersion of iron nitride particles of ε-Fe₃N and/or ζ-Fe₂N was observed in the microstructure at a position of 70 μm depth from the surface.

However, in the case of test mark 5-q, since the tempering temperature is 180° C. and the heat treatment condition of the present invention is not satisfied, retained austenite did not sufficiently undergo bainite transformation, and a “lath-like bainite structure” similar to the case of the foregoing examples of the present invention was not obtained. In the case of test mark 5-r, since the tempering temperature is as high as 400° C. and the heat treatment condition of the present invention is not satisfied, retained austenite was decomposed into ferrite, cementite, and rod-like coarse γ′-Fe₄N nitride, and a “lath-like bainite structure” similar to the case of the foregoing examples of the present invention was not obtained.

Since the effective hardening depth of the above-described test marks is 610 to 640 μm, the foregoing “position of 70 μm depth from the surface” is well within a region that matches the “region to a position of effective hardening depth from the surface of a hardened layer” specified by the present invention.

As described above, in the case of test marks 5-q and 5-r, since both do not have the microstructure specified by the present invention, the surface layer hardness is as low as 535 and 625 in Vickers hardness scale, respectively, in the roller pitting test at a surface pressure of 2800 MPa, fatigue removal occurred at the accumulated rotation cycle of 2.6×10⁵ cycles and 1.4×10⁶ cycles, respectively, and pitting strength is low. Further, in the case of the above-described test marks, the widths of abrasion groove are 2020 μm and 1580 μm, respectively, largely exceeding 1000 μm; and thus each abrasion strength thereof was also inferior.

### INDUSTRIAL APPLICABILITY

The carbonitrided part of the present invention has excellent abrasion strength and high pitting strength. Hence, in order to realize weight saving of a car directly linked to the improvement of energy efficiency, it can be used in power transmission components such as gear for a transmission and pulley for a belt-type continuously variable transmission of a car requiring more miniaturization and higher strength. In addition thereto, the carbonitrided part of the present invention can be produced by a method of the present invention, and a material of the carbonitrided part is a low-cost steel with less content of Mo of an expensive alloy element or without addition of Mo. Thus, it is possible to realize the reduction of production costs in comparison with the conventional power transmission components.

What is claimed is:

1. A carbonitrided part, characterized in that:
a base steel of the carbonitrided part comprises, in mass percent, C: 0.10 to 0.35%, Si: 0.15 to 1.0%, Mn: 0.30 to 1.0%, Cr: 0.40 to 2.0%, S: 0.05% or less, with the balance being Fe and impurities;
in the region from the surface of a hardened layer of the carbonitrided part to a position of effective hardening depth thereof, iron nitride particles of ε-Fe₃N and/or ζ-Fe₂N are dispersed, and retained austenite is decomposed into bainitic ferrite, Fe₃C, and α″-Fe₁₆N₂.

2. The carbonitrided part according to claim 1, characterized in that the base steel further contains, in mass percent, Mo: 0.50% or less in lieu of a part of Fe.

3. A process for producing a carbonitrided part, comprising the steps of:
preparing a base steel part, having a composition comprising, in mass percent, C: 0.10 to 0.35%, Si: 0.15 to 1.0%, Mn: 0.30 to 1.0%, Cr: 0.40 to 2.0%, S: 0.05% or less, with the balance being Fe and impurities;
performing treatments including the following steps 1 to 4 in sequence:
Step 1: Carburizing the base steel part under a carburizing atmosphere at a temperature of 900 to 950° C.;
Step 2: Carbonitriding the base steel part carburized according to step 1 under a carbonitriding atmosphere at a temperature of 800 to 900° C. with a nitrogen potential of 0.2 to 0.6%;
Step 3: Quenching the base steel part carbonitrided according to step 2;
Step 4: Tempering the base steel part quenched according to step 3 at a temperature of more than 250° C. to not more than 350° C.

4. The process for producing a carbonitrided part according to claim 3, characterized in that the base steel further contains, in mass percent, Mo: 0.50% or less in lieu of a part of Fe.
